(19) United States
(12) Patent Application Publication
(10) Pub. No.: US 2018/0004216 A1
(43) Pub. Date: Jan. 4, 2018

(54) Methods and Systems for Autonomously Tracking a Target Object

(71) Applicant: Sharp Laboratories of America, Inc., Camas, WA (US)

(72) Inventors: Ahmet Mufit Ferman, Vancouver, WA (US); Basil Isaiah Jesudason, Portland, OR (US); Darin Joseph Haines, Washougal, WA (US)

(73) Assignee: Sharp Laboratories of America, Inc., Camas, WA (US)

(21) Appl. No.: 15/197,659

(22) Filed: Jun. 29, 2016

(51) Int. Cl. G05D 1/02; H04W 4/02; G08G 3/00; G05D 1/00; G01S 19/51; H04W 4/04; G01C 21/10

(52) U.S. Cl. CPC G05D 1/0221; H04W 4/046; H04W 4/027; H04W 4/023; G01C 21/10; G05D 1/0287; G05D 1/0088; G01S 19/51; G08G 3/00

(57) ABSTRACT

Aspects of the present invention relate to systems and methods for autonomously tracking a target object.

### FIELD OF THE INVENTION

Embodiments of the present invention relate generally to methods and systems for autonomous navigation and, in particular, to methods and systems for autonomously tracking a target object.

### BACKGROUND

It may be desirable for an autonomous vehicle to track, without direct, manual supervision, a path defined by a target object, for example, a person, a vehicle and other target objects capable of traversing a route. Furthermore, methods and systems for providing this capability without requiring significant modification of existing path-tracking algorithms may be advantageous.

### SUMMARY

Some embodiments of the present invention comprise methods and systems for autonomously tracking a target object.

According to a first aspect of exemplary embodiments of the present invention, a target-learner system may comprise a target device and a learner device.

According to a second aspect of exemplary embodiments of the present invention, the learner device may receive location information from the target device and effectuate navigation to a location corresponding to the location information.

According to a third aspect of exemplary embodiments of the present invention, a spatial relationship between the target device and the learner device may be established.

According to a fourth aspect of exemplary embodiments of the present invention, the learner device may receive location information from the target device and effectuate navigation to a location corresponding to the location information and maintaining the established spatial relationship.

According to a fifth aspect of exemplary embodiments of the present invention, supplementary information may be transmitted to the learner device from the target device.

According to a sixth aspect of exemplary embodiments of the present invention, the learner device may use the supplementary information to effectuate navigation to a location corresponding to the location information.

According to a seventh aspect of exemplary embodiments of the present invention, a target-learner system may comprise a target device, a learner device and a server system.

According to an eighth aspect of exemplary embodiments of the present invention, the target device may transmit location information to the server system.

According to a ninth aspect of exemplary embodiments of the present invention, the target device may transmit supplementary information to the server system.

According to a tenth aspect of exemplary embodiments of the present invention, the server system may transmit location information to the learner device.

According to an eleventh aspect of exemplary embodiments of the present invention, the server system may transmit supplementary information to the learner device.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating a target-learner system, according to embodiments of the present invention, comprising a learner device comprising one, or more, navigation device(s), one, or more, on-board sensor(s), one, or more, control system(s), a receiving component and a memory, and a target device comprising a collection component, a recording component and a transmitting component;

FIGS. 2A-2D are a chart showing exemplary embodiments of the present invention comprising a method, also referred to as a route-instruction operation, by which a learner device may traverse a path defined by a target device;

FIGS. 3A-3C are a chart showing exemplary embodiments of the present invention comprising a method by which a target device may define a path to be traversed by a learner device;

FIGS. 4A-4F are a chart showing exemplary embodiments of the present invention comprising a method by which a target device may define a path to be traversed by a learner device;

FIGS. 5A-5D are a chart showing exemplary embodiments of the present invention comprising a method, also referred to as a route-instruction operation, by which a learner device may traverse a path defined by a target device;

FIGS. 6A-F are a chart showing exemplary embodiments of the present invention comprising a method by which a target device may define a path to be traversed by a learner device;

FIGS. 7A-7D are a chart showing exemplary embodiments of the present invention comprising a method, also referred to as a route-instruction operation, by which a learner device may traverse a path defined by a target device;

FIGS. 8A-8C are a chart showing exemplary embodiments of the present invention comprising a method by which a target device may define a path to be traversed by a learner device;

FIGS. 9A-9F are a chart showing exemplary embodiments of the present invention comprising a method by which a target device may define a path to be traversed by a learner device;

FIG. 10 is a picture illustrating a target-learner system, according to embodiments of the present invention, comprising a learner device comprising one, or more, navigation device(s), one, or more, on-board sensor(s), one, or more, control system(s), a receiving/transmitting component and a memory, a target device comprising a collection component, a recording component, one, or more, sensor(s) and a transmitting component, and a server system comprising a receiving component, a transmitting component, a memory and a processor;

FIGS. 11A-11D are a chart showing exemplary embodiments of the present invention comprising a method, also referred to as a route-instruction operation, by which a learner device may traverse a path defined by a target device, wherein the target device and the learner device connect to a server system;

FIGS. 12A-12C are a chart showing exemplary embodiments of the present invention comprising a method by which a target device may define a path to be traversed by a learner device, wherein the target device and the learner device connect to a server system; and

FIG. 13 is a chart showing exemplary embodiments of the present invention comprising a method at a server system for teaching a learner device to navigate based on a target device position.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods, systems and apparatus of the present invention is not intended to limit the scope of the invention, but it is merely representative of the presently preferred embodiments of the invention.

Elements of embodiments of the present invention may be embodied in hardware, firmware and/or a non-transitory computer program product comprising a computer-readable storage medium having instructions stored thereon/in which may be used to program a computing system. While exemplary embodiments revealed herein may only describe one of these forms, it is to be understood that one skilled in the art would be able to effectuate these elements in any of these forms while resting within the scope of the present invention.

Although the charts and diagrams in the figures may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that a non-transitory computer program product comprising a computer-readable storage medium having instructions stored thereon/in which may be used to program a computing system, hardware and/or firmware may be created by one of ordinary skill in the art to carry out the various logical functions described herein.

It may be desirable for an autonomous vehicle to track, without direct, manual supervision, a path defined by a target object, for example, a person, a vehicle and other target objects capable of traversing a route. Furthermore, methods and systems for providing this capability without requiring significant modification of existing path-tracking algorithms may be advantageous.

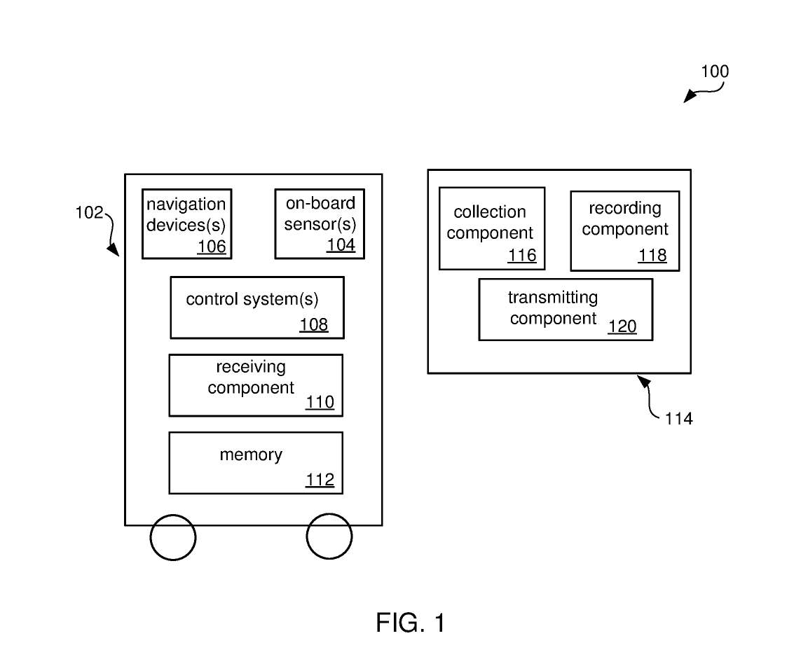

Some embodiments of the present invention may be described in relation to FIG. 1. A target-learner system 100 may comprise a learner device 102 capable of navigating a route, also referred to as a path. Exemplary learner devices include autonomous navigation vehicles, robots and other learner devices. The learner device 102 may comprise one, or more, on-board sensors 104 for sensing environmental and/or surrounding conditions, one, or more, navigation devices 106 for providing and analyzing navigation-related information, one, or more, control systems 108 for effectuating controlled movement of the learner device, a receiving component 110 for receiving location and other information and a memory 112 for storing information.

The target-learner system 100 may further comprise a target device 114 comprising a collection component 116 for collecting location information, a recording component 118 for recording the location information and a transmitting component 120 for transmitting the location information to the learner device 102. Exemplary location information may include longitude and latitude information, for example, GPS coordinates and other longitude and latitude information, displacement and heading information relative to a fixed location and other location information.

In alternative embodiments, not shown, a target device may additionally comprise one, or more, on-board sensor(s), and the transmitting component may transmit supplementary information in addition to location information.

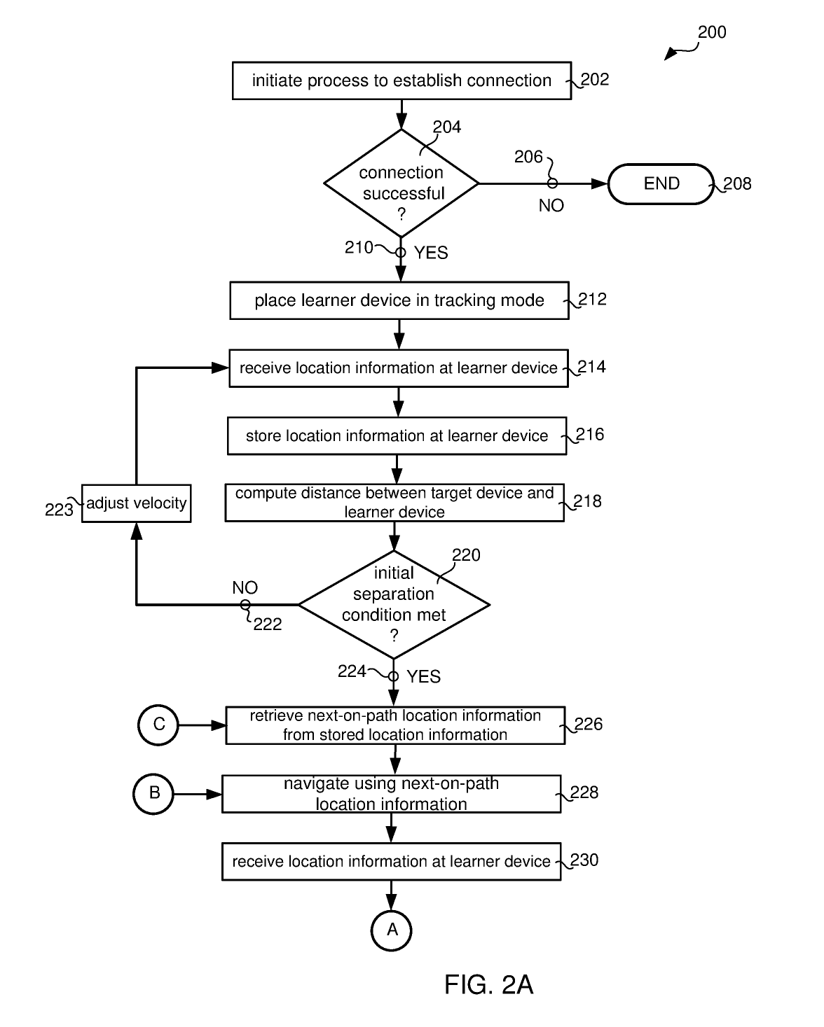

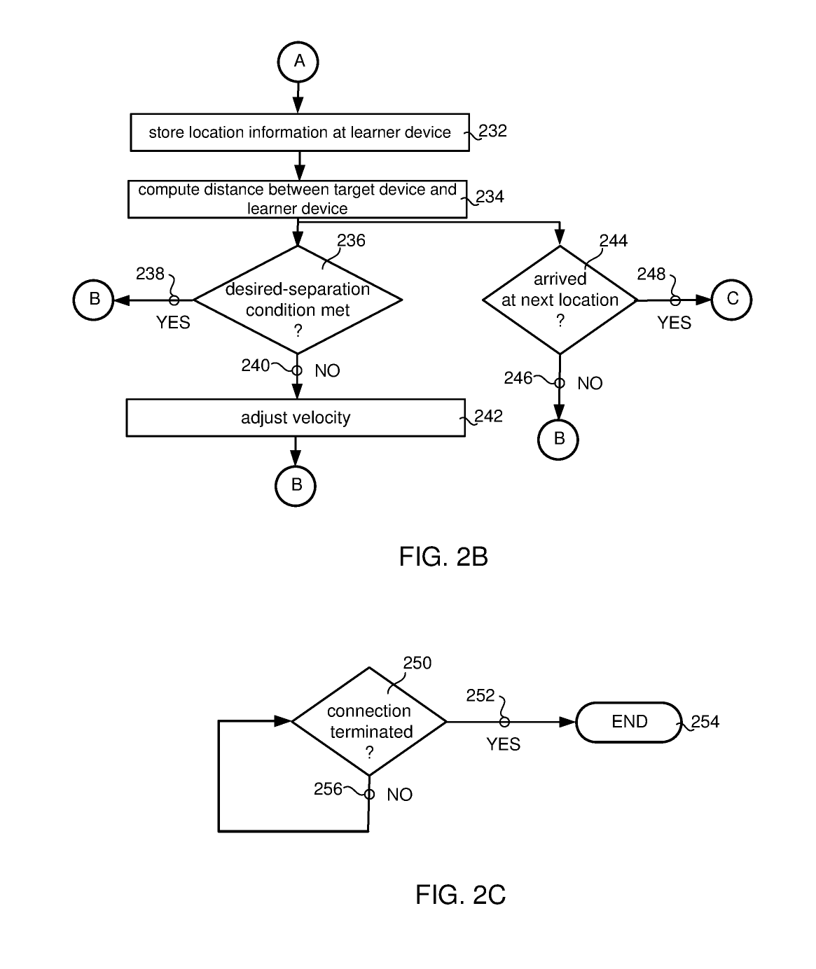

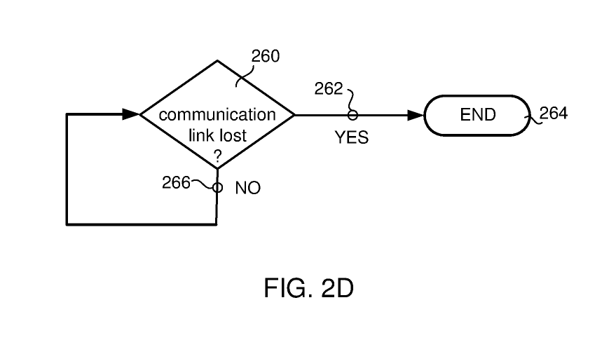

Some embodiments of the present invention, described in relation to FIGS. 2A-2D, may comprise a method 200, also referred to as a route-instruction operation, by which a learner device may track a target device and traverse a path defined by the target device. In some embodiments of the present invention, the learner device may track the target device from behind the target device. This may be referred to as “pull” tracking. In alternative embodiments of the present invention, the learner device may track the target device from in front of the target device. This may be referred to as “push” tracking.

Either the learner device or the target device may initiate 202 a connection process to establish a connection with the other device. A determination may be made 204 as to whether, or not, the connection was successfully established. If the connection was not 206 successfully established, for example, due to privilege issues, communication link issues, power issues and other reasons for connection failure, the method 200 may terminate 208.

In alternative embodiments, not shown, if a connection is not successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish a connection between the learner device and the target device may comprise an authentication process to verify that the target device and the learner device each have sufficient privileges to participate in the route-instruction operation 200. In these exemplary embodiments, if either device is not authorized to participate in the route-instruction operation 200, the connection may not 206 be successfully established, and the method 200 may terminate 208.

If a connection is 210 successfully established between the learner device and the target device, then the learner device may be placed 212 in tracking mode. The learner device may receive 214 location information, from the target device, describing the current location of the target device. The learner device may store 216 the location information and compute 218 the distance between the target device and the learner device. A determination may be made 220 as to whether, or not, an initial separation condition, between the learner device and the target device, is met.

The initial separation condition may be based on a desired amount of initial separation between the learner device and the target device. In some embodiments of the present invention, the desired amount of initial separation may be an initial distance range in which the computed distance is desired to fall. In some embodiments of the present invention, the determination may comprise comparison of the computed distance with a maximum-separation threshold and a minimum-separation threshold. In some embodiments, the maximum-separation threshold may be a fixed, pre-defined value. In alternative embodiments, the maximum-separation threshold may be dependent on other constraints, for example, environmental conditions, target-device speed, transmission-link strength and other constraints. In some embodiments, the minimum-separation threshold may be a fixed, pre-defined value. In alternative embodiments, the minimum-separation threshold may be dependent on other constraints, for example, environmental conditions, target-device speed, transmission-link strength and other constraints.

In some alternative embodiments of the present invention, only a minimum separation may be desired.

In other alternative embodiments of the present invention, only a maximum separation may be desired.

If the initial separation condition is not 222 met, then the learner device may adjust 223 its velocity to effectuate the desired separation, continue to receive 214 location information from the target device, store 216 the location information and compute 218 the distance between the target device and the learner device until the initial separation condition is 224 met.

In some “pull” tracking embodiments, if the initial separation condition is a condition requiring a minimum separation between the target device and the learner device, then adjustment 223 of the learner-device velocity may comprise waiting until the minimum separation is attained. In alternative “pull” tracking embodiments, if the initial separation condition is a condition requiring no more than a maximum separation between the target device and the learner device, then adjustment 223 of the learner-device velocity may comprise an increase in speed in the direction of travel of the target device, which may be determined from the stored location information.

In some “push” tracking embodiments, if the initial separation condition is a condition requiring a minimum separation between the target device and the learner device, then adjustment 223 of the learner-device velocity may comprise an increase in speed of the learner device in the direction of travel of the target device, which may be determined from the stored location information. In alternative “push” tracking embodiments, if the initial separation condition is a condition requiring no more than a maximum separation between the target device and the learner device, then adjustment 223 of the learner-device velocity may comprising waiting until the minimum separation is attained.

If the initial separation condition is 224 met, then a next-on-path location information, relative to the learner device's current location, may be retrieved 226 from the stored location information. The learner system may navigate 228 using the next-on-path location information.

In some “pull” tracking embodiments, the learner device may navigate 228 toward a location, also referred to as the next location, corresponding to the most-recently-retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 228 toward the location corresponding to the most-recently-retrieved location information.

In some “push” tracking embodiments, the learner device may navigate 228 toward a location, also referred to as the next location, using a heading and displacement defined by the most-recently-retrieved location information. The next location may be a location defined relative to the previous location using a heading and displacement calculated using the most-recently retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 228 toward the next location.

While navigating 228 using the most-recently-retrieved location information, the learner system may continue to: receive 230 location information; store 232 the received location information; and compute 234 the distance between the target device and the learner device.

A determination may be made 236 as to whether, or not, a desired-separation condition is met. In some embodiments of the present invention, the method of determination 236 of whether, or not, the desired-separation condition is met made when the learner device is navigating may be the same as the method of determination 220 of whether, or not, the initial separation condition is met made when the learner device is initially beginning to track the target device. In alternative embodiments, the method of determination 236 of whether, or not, the desired-separation condition is met made when the learner device is navigating may be a different method than the method of determination 220 of whether, or not, the initial separation condition is met made when the learner device is initially beginning to track the target device.

If the desired-separation condition is 238 met, then the learner device may continue to: navigate 228 using the most-recently-retrieved location information; receive 230 location information; store 232 location information; and compute 234 the distance between the target device and the learner device.

If the desired-separation condition is not 240 met then the learner device may adjust 242 its velocity accordingly in an effort to effectuate the required desired separation, while then continuing to: navigate 228 using the most-recently-retrieved location information; receive 230 location information; store 232 location information and; compute 234 the distance between the target device and the learner device.

The learner device may monitor to determine 244 if the learner device has arrived at the next location.

If the learner device has not 246 arrived at the next location, then the learner device may continue to: navigate 228 to the next location; receive 230 location information; store 232 location information; and compute 234 the distance between the target device and the learner device.

If the learner device has 248 arrived at the next location, then learner device may retrieve 226 the next-on-path location information, relative to the learner device's current location, from the stored location information, and the method 200 may continue.

The learner device may monitor to determine 250 if the connection between the target device and the learner device has been terminated by the target device. If the connection has 252 terminated, then the method 200 may end 254. If the connection has not 256 terminated, the monitoring of connection termination may continue.

The learner device may monitor to determine 260 if the communication link between the learner device and the target device has been lost. If the communication link has 262 been lost, then the method 200 may end 264. If the communication link has not 266 been lost, then the monitoring of communication link integrity may continue.

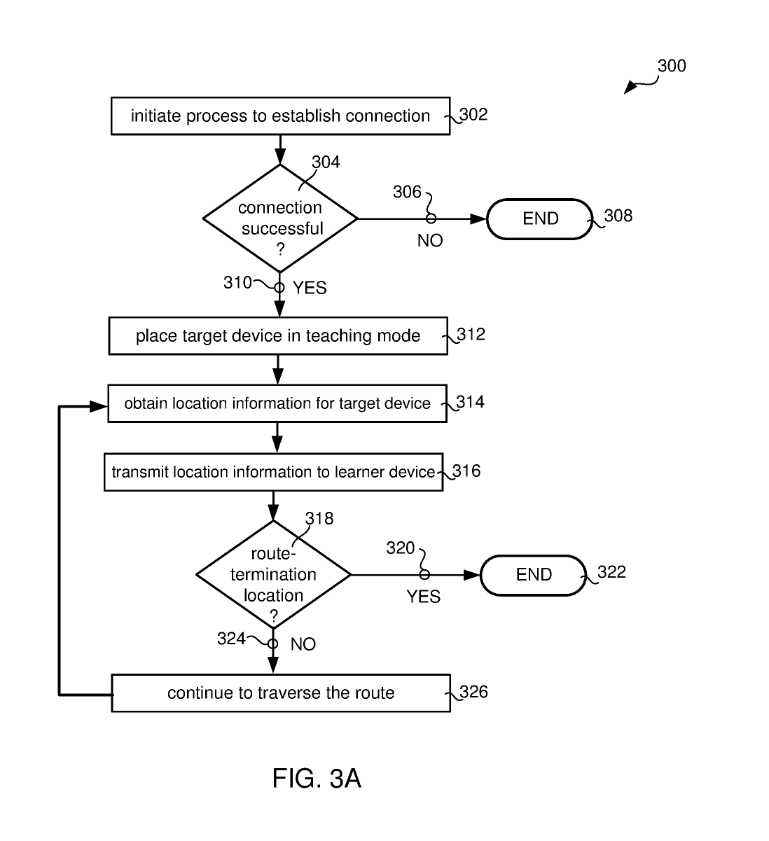

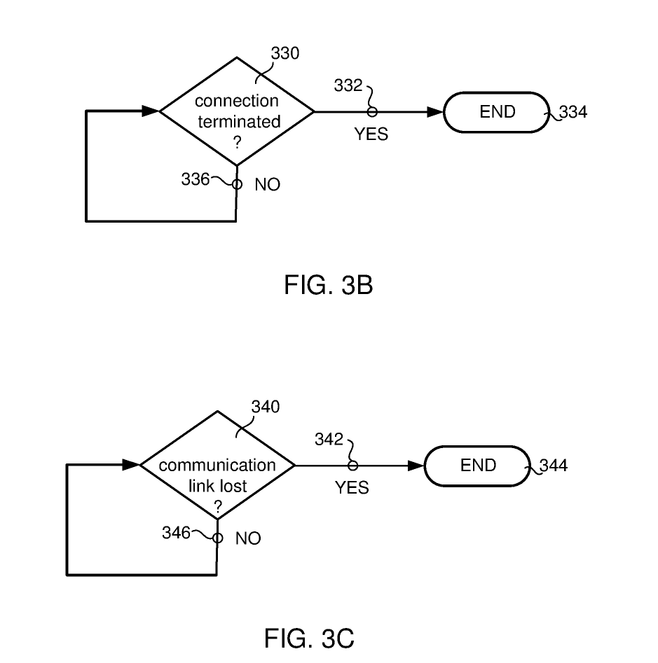

Some embodiments of the present invention, described in relation to FIG. 3A-3C, may comprise a method 300 by which a target device may define a path to be traversed by a learner device, also referred to as a route-definition operation. Either the learner device or the target device may initiate 302 a connection process to establish a connection with the other device. A determination may be made 304 as to whether, or not, the connection was successfully established. If the connection was not 306 successfully established, for example, due to privilege issues, communication link issues, power issues and other reasons for connection failure, the method 300 may terminate 308. In alternative embodiments, not shown, if the connection was not 306 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish a connection between the learner device and the target device may comprise an authentication process to verify that the target device and the learner device each have sufficient privileges to participate in the route-definition operation 300. In these exemplary embodiments, if either device is not authorized to participate in the route-instruction operation, the connection may not 306 be successfully established, and the method 300 may terminate 308.

If a connection is 310 successfully established between the learner device and the target device, then the target device may be placed 312 in teaching mode, and location information describing the current location of the target device may be obtained 314 and transmitted 316 to the learner device. The location information for the current location of the target device may be transmitted 316 to the learner device.

A determination 318 may be made to determine if the target device is at the route-termination location. If the target is 320 at the route-termination location, then the method 300 may end 322. In some embodiments of the present invention, the ending 322 of the method 300 may comprise transmitting a route-termination flag, or other indicator, to the learner device.

If the target device is not 324 at the route-termination location, then the target device may continue to traverse 326 the route. The location information for the current location of the target device may be obtained 314 and transmitted 316 to the learner device. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms. In yet other alternative embodiments, location information may be obtained using a combination of a set frequency and operator requests.

In some embodiments of the present invention, the frequency at which location information is obtained and the frequency at which location information is transmitted may be different. In alternative embodiments, location information may be obtained and transmitted at the same frequency.

The target device may monitor to determine 330 if the connection between the target device and the learner device has been terminated by the learner device. If the connection has 332 terminated, then the method 300 may end 334. If the connection has not 336 terminated, the monitoring of connection termination may continue.

The target device may monitor to determine 340 if the communication link between the learner device and the target device has been lost. If the communication link has 342 been lost, then the method 300 may end 344. If the communication link has not 346 been lost, then the monitoring of communication link integrity may continue.

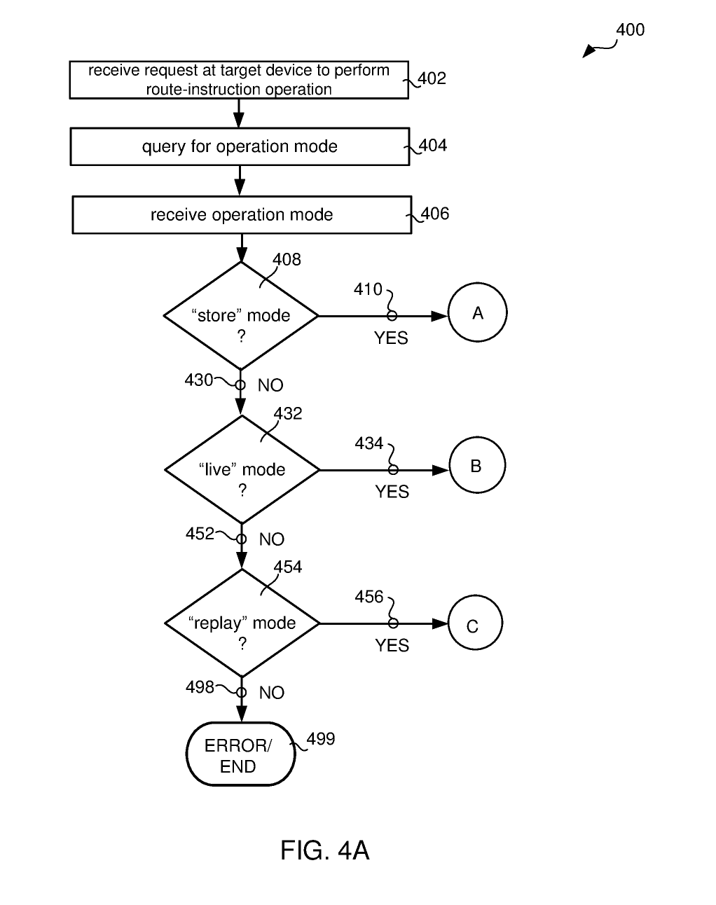

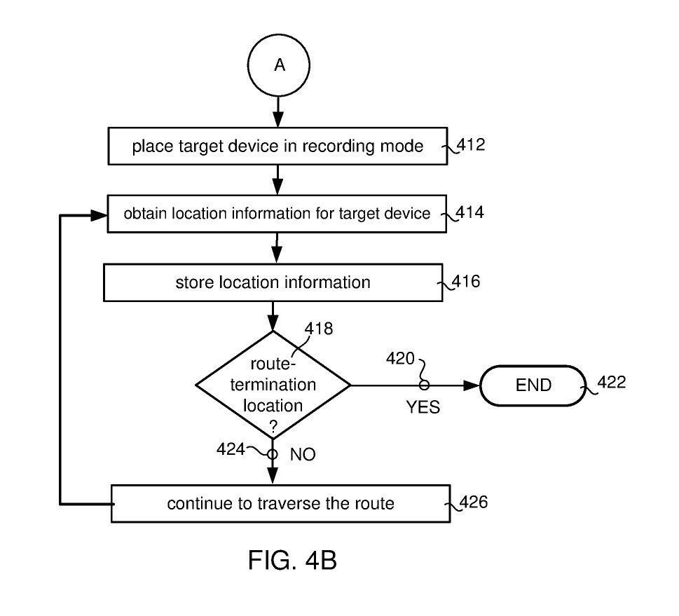

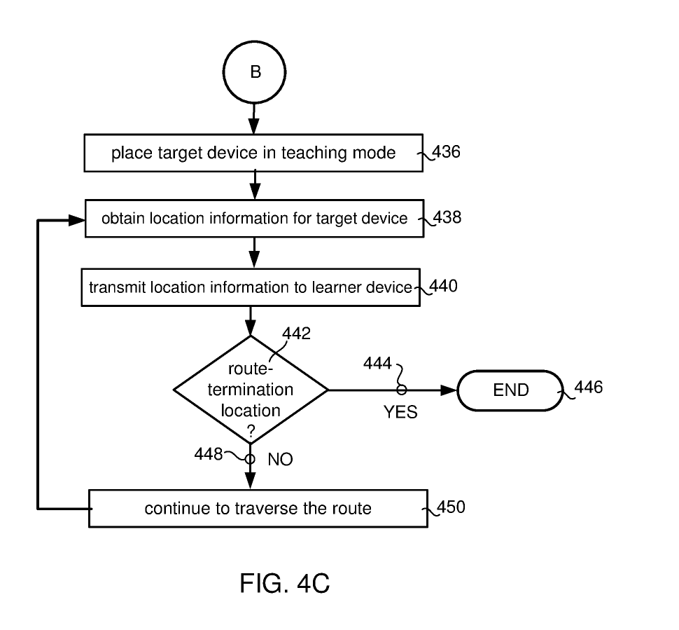

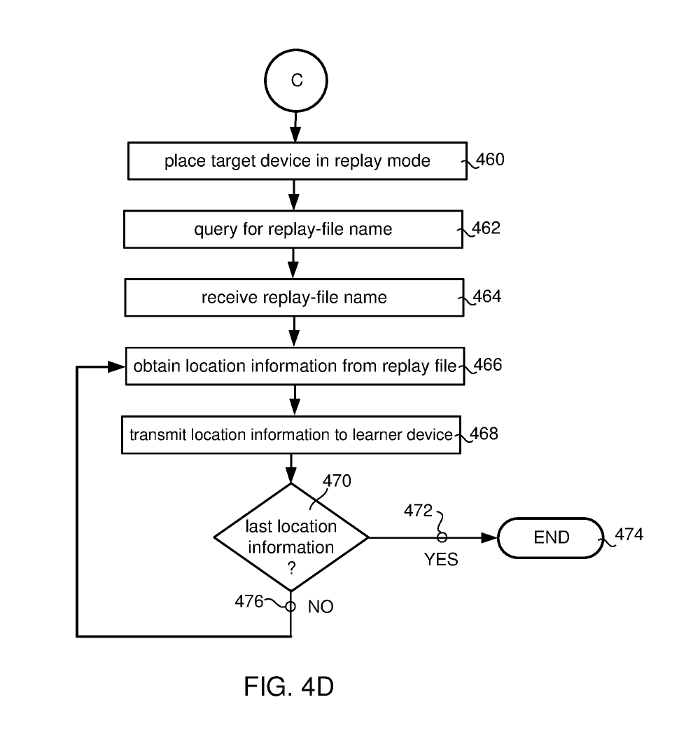

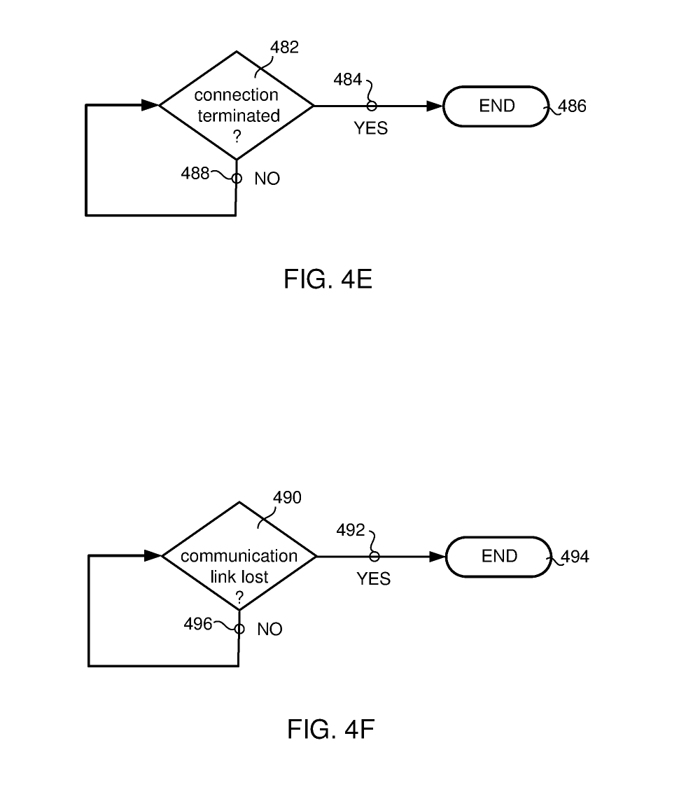

Some embodiments of the present invention, described in relation to FIGS. 4A-4F, may comprise a method 400 by which a target device may define a path to be traversed by a learner device.

The target device may receive 402 a request to perform a route-instruction operation. The request may be from a learner device, a request generated at the target device or a request generated at a remote computing device. The target device may query 404, the device from which the request was sent, for an operation mode. The target device may receive 406 the operation mode from the device from which the request was made.

A determination may be made 408 to determine if the requested operation mode is a “store” mode. If the operation mode is 410 a “store” mode, then the target device may be placed 412 in the recording mode. The current location information for the target device may be obtained 414. The location information for the current location of the target device may be stored 416. In some embodiments of the present invention, the location information may be stored on the target device, on a server or on other non-local storage.

A determination 418 may be made to determine if the target device is at the route-termination location. If the target is 420 at the route-termination location, then the method 400 may end 422. In some embodiments of the present invention, the ending 422 of the method 400 may comprise storing a route-termination flag, or other indicator.

If the target device is not 424 at the route-termination location, then the target device may continue to traverse 426 the route, and the location information for the current location of the target device may be obtained 414. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms. In yet other alternative embodiments, location information may be obtained using a combination of a set frequency and operator requests.

If the operation mode is not 430 the “store” mode, then a determination 432 may be made to determine if the operation mode is the “live” mode. If the operation mode is 434 the “live” mode, then the target device may be placed 436 in teaching mode, and the location information for the current location of the target device may be obtained 438. The location information for the current location of the target device may be transmitted 440 to the learner device.

A determination 442 may be made to determine if the target device is 444 at the route-termination location. If the target is 444 at the route-termination location, then the method 400 may end 446. In some embodiments of the present invention, the ending 446 of the method 400 may comprise transmitting a route-termination flag, or other indicator, to the learner device.

If the target device is not 448 at the route-termination location, then the target device may continue to traverse 450 the route, and the location information for the current location of the target device may be obtained 438. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms. In yet other alternative embodiments, location information may be obtained using a combination of a set frequency and operator requests.

If the operation mode is not 452 the “live” mode, then a determination 454 may be made to determine if the operation mode is the “replay” mode. If the operation mode is 456 the “replay” mode, then the target device may be placed 460 in replay mode, and the target device may query 462 the requesting device for a replay-file name. The target device may receive 464 the replay-file name and obtain 466 location information from the replay file. The obtained location information may be transmitted 468 to the learner device.

A determination 470 may be made to determine if the obtained location information is the last location information in the replay file. If the location information is 472 the last location information in the replay file, then the method 400 may end 474. In some embodiments of the present invention, the ending 474 of the method 400 may comprise transmitting a route-termination flag, or other indicator, to the learner device.

If the obtained location information is not 476 at the last location information in the replay file, then the target device may obtain 466 the next location information from the replay file. In some embodiments of the present invention, the location information may be replayed at a set frequency. In some embodiments of the present invention, the set frequency may be communicated from the target device to the learner device. In alternative embodiments, the learner device may communicate to the target device a frequency at which the learner device desires to receive the location information. In still alternative embodiments of the present invention, the target device may wait for a transmit request from the learner device.

If the mode is “live” or “replay,” the target device may monitor to determine 482 if the connection between the target device and the learner device has terminated by the learner device. If the connection has 484 terminated, then the method 400 may end 486. If the connection has not 488 terminated, the monitoring of connection termination may continue.

If the mode is “live” or “replay,” the target device may monitor to determine 490 if the communication link between the learner device and the target device has been lost. If the communication link has 492 been lost, then the method 400 may end 494. If the communication link has not 496 been lost, then the monitoring of communication link integrity may continue.

If the operation mode is not 498 the “replay” mode, then the method 400 may terminate 499 with an error communication.

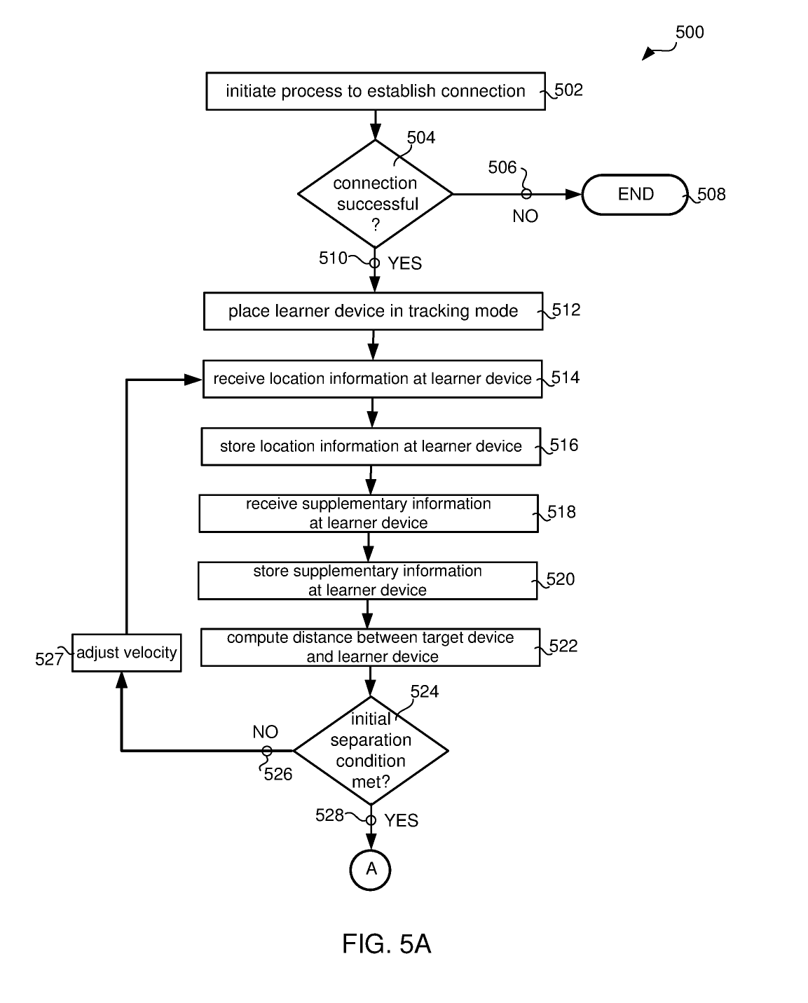

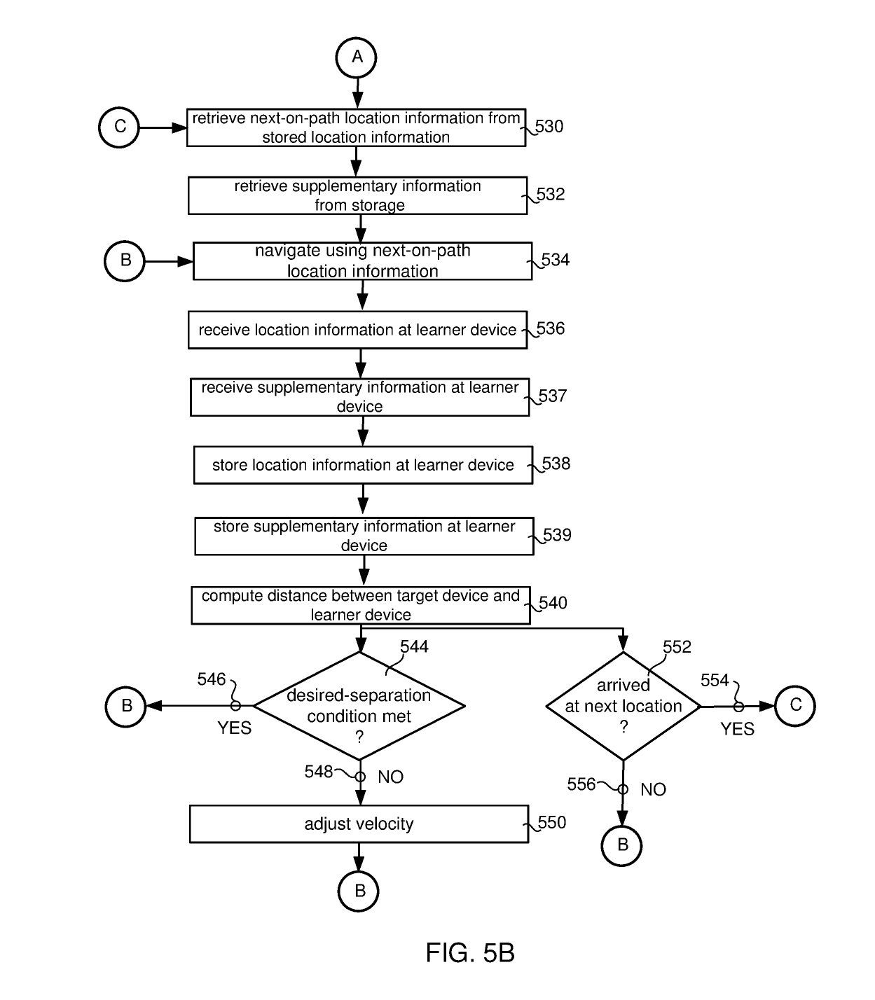

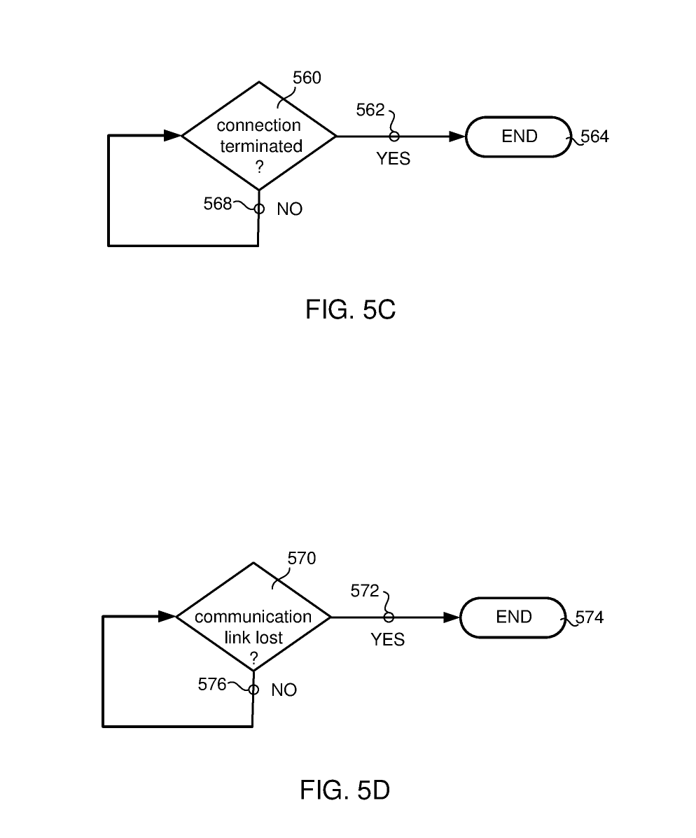

Some embodiments of the present invention, described in relation to FIGS. 5A-5D, may comprise a method 500, also referred to as a route-instruction operation, by which a learner device may track a target device and traverse a path defined by the target device. In some embodiments of the present invention, the learner device may track the target device from behind the target device. This may be referred to as “pull” tracking. In alternative embodiments of the present invention, the learner device may track the target device from in front of the target device. This may be referred to as “push” tracking.

Either the learner device or the target device may initiate 502 a connection process to establish a connection with the other device. A determination may be made 504 as to whether, or not, the connection was successfully established. If the connection was not 506 successfully established, for example, due to privilege issues, communication link issues, power issues and other reasons for connection failure, the method 500 may terminate 508. In alternative embodiments, not shown, if the connection was not 506 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish 502 a connection between the learner device and the target device may comprise an authentication process to verify that the target device and the learner device each have sufficient privileges to participate in the route-instruction operation 500. In these exemplary embodiments, if either device is not authorized to participate in the route-instruction operation, the connection may not 506 be successfully established, and the method 500 may terminate 508.

If a connection is 510 successfully established between the learner device and the target device, then the learner device may be placed 512 in tracking mode. The learner device may receive 514 location information from the target device and may store 516 the location information. The learner device may receive 518 supplementary information from the target device and may store 520 the supplementary information. Examples of supplementary information include information about the environment in which the target and/or learner device(s) may operate, for example, exclusion zones in which travel is not allowed and other operational information, information to augment positional data, for example, visual information, which may be analyzed using image enhancement, reconstruction and understanding methods known in the art, collected by a camera on the target device, environmental information, for example, weather conditions, path conditions and other environment information, which may be used to infer accuracy and other reliability information with respect to the location information, and other supplementary information.

The learner device may compute 522 the distance between the target device and the learner device.

A determination may be made 524 as to whether, or not, an initial separation condition, between the learner device and the target device, is met.

The initial separation condition may be based on a desired amount of initial separation between the learner device and the target device. In some embodiments of the present invention, the desired amount of initial separation may be an initial distance range in which the computed distance is desired to fall. In some embodiments of the present invention, the determination may comprise comparison of the computed distance with a maximum-separation threshold and a minimum-separation threshold. In some embodiments, the maximum-separation threshold may be a fixed, pre-defined value. In alternative embodiments, the maximum-separation threshold may be dependent on other constraints, for example, environmental conditions, target-device speed, transmission-link strength and other constraints. In some embodiments, the minimum-separation threshold may be a fixed, pre-defined value. In alternative embodiments, the minimum-separation threshold may be dependent on other constraints, for example, environmental conditions, target-device speed, transmission-link strength and other constraints.

In some alternative embodiments of the present invention, only a minimum separation may be desired.

In other alternative embodiments of the present invention, only a maximum separation may be desired.

If the initial separation condition is not 526 met, then the learner device may adjust 527 its velocity to effectuate the desired separation. The learner device may continue to receive 514 and store 516 location information from the target device and to receive 518 and store 520 supplementary information. The learner device may compute 522 the distance between the target device and the learner device until the initial separation condition is 528 met.

In some “pull” tracking embodiments, if the initial separation condition is a condition requiring a minimum separation between the target device and the learner device, then adjustment 527 of the learner-device velocity may comprise waiting until the minimum separation is attained. In alternative “pull” tracking embodiments, if the initial separation condition is a condition requiring no more than a maximum separation between the target device and the learner device, then adjustment 527 of the learner-device velocity may comprise an increase in speed in the direction of travel of the target device.

In some “push” tracking embodiments, if the initial separation condition is a condition requiring a minimum separation between the target device and the learner device, then adjustment 527 of the learner-device velocity may comprise an increase in speed of the learner device in the direction of travel of the target device. In alternative “push” tracking embodiments, if the initial separation condition is a condition requiring no more than a maximum separation between the target device and the learner device, then adjustment 527 of the learner-device velocity may comprising waiting until the minimum separation is attained.

If the initial separation condition is 528 met, then the next-on-path location information relative to the learner device's current location may be retrieved 530 from the stored location information and the corresponding supplementary information may be retrieved 532 from storage. The learner device may navigate 534 using the next-on-path location information and may use the corresponding supplementary information to assist in the navigation process.

In “pull” tracking embodiments, the learner device may navigate 534 toward a location, also referred to as the next location, defined by the most-recently-retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 534 toward the location defined by the most-recently-retrieved location information.

One of ordinary skill in the will appreciate a multitude of autonomous navigation algorithms, for example, pure pursuit path tracking and other algorithms known in the art, available to be used to provide a navigation capability to effectuate the learner-device navigation 534 toward a location defined by the most-recently-retrieved location information.

In some “push” tracking embodiments, the learner device may navigate 534 toward a location, also referred to as the next location, using a heading and displacement defined by the most-recently-retrieved location information. The next location may be a location defined relative to the previous location using a heading and displacement calculated using the most-recently retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 534 toward the next location.

While navigating to the next location, the learner system may continue to: receive 536 location information; receive 537 supplementary information; store 538 the received location information; store 539 the received supplementary information; and compute 540 the distance between the target device and the learner device.

A determination may be made 544 as to whether, or not, a desired-separation condition is met. In some embodiments of the present invention, the method of determination 544 of whether, or not, the desired-separation condition is met made when the learner device is navigating may be the same as the method of determination 524 of whether, or not, the initial separation condition is met made when the learner device is initially beginning to track the target device. In alternative embodiments, the method of determination 544 of whether, or not, the desired-separation condition is met made when the learner device is navigating may be a different method than the method of determination 524 of whether, or not, the initial separation condition is met made when the learner device is initially beginning to track the target device.

If the desired-separation condition 546 is met, then the learner device may continue to: navigate 534 using the most-recently-retrieved location information; receive 536 and store 538 location information; receive 537 and store 539 supplementary information; and compute 540 the distance between the target device and the learner device.

If the device-separation condition is not 548 met, then the learner device may adjust 550 its velocity accordingly in an effort to maintain the desired separation, while then continuing to: navigate 534 using the most-recently-retrieved location information; receive 536 and store 538 location information; receive 537 and store 539 supplementary information; and compute 540 the distance between the target device and the learner device.

The learner device may monitor to determine 552 if the learner device has arrived at the next location. If the learner device has not 556 arrived at the next location, then the learner device may continue to: navigate 534 to the next location; receive 536 and store 538 location information; receive 537 and store 539 supplementary information; and compute 540 the distance between the target device and the learner device.

If the learner device has 554 arrived at the next location, then learner device may retrieve 530 the next-on-path location information relative to the learner device's current location from the stored location information, and the method 500 may continue.

The learner device may monitor to determine 560 if the connection between the target device and the learner device has been terminated by the target device. If the connection has 562 terminated, then the method 500 may end 564. If the connection has not 568 terminated, the monitoring of connection termination may continue.

The learner device may monitor to determine 570 if the communication link between the learner device and the target device has been lost. If the communication link has 572 been lost, then the method 500 may end 574. If the communication link has not 576 been lost, then the monitoring of communication link integrity may continue.

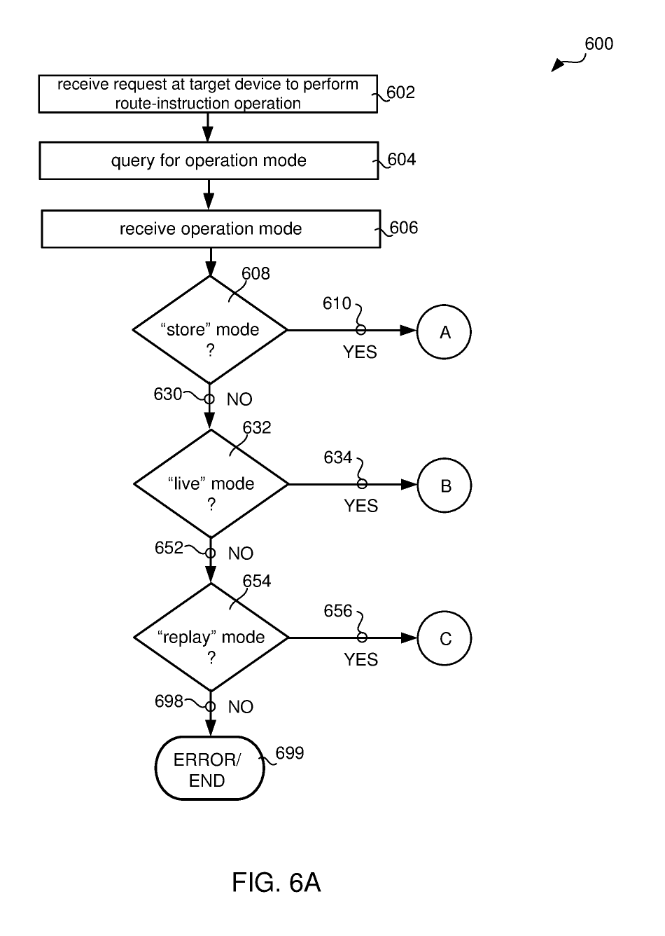

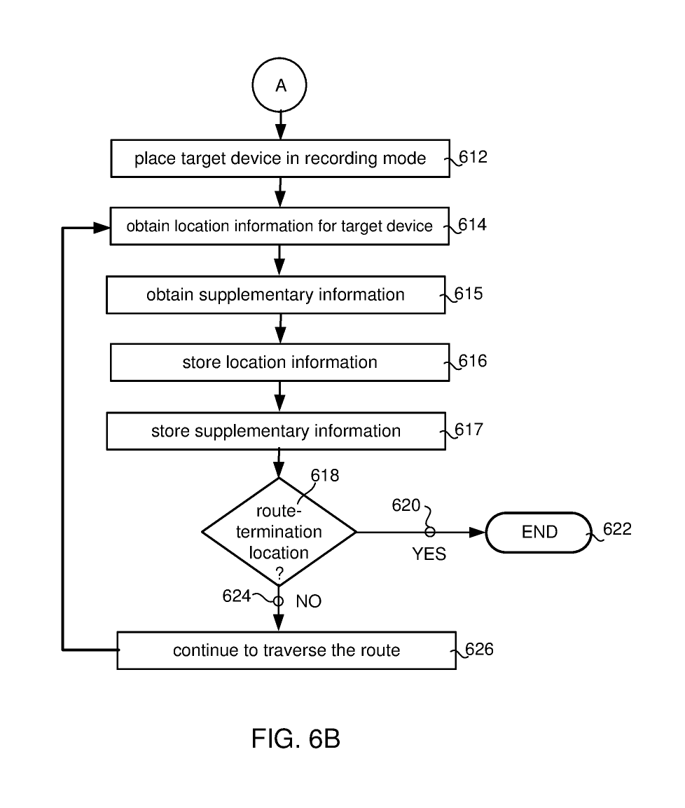

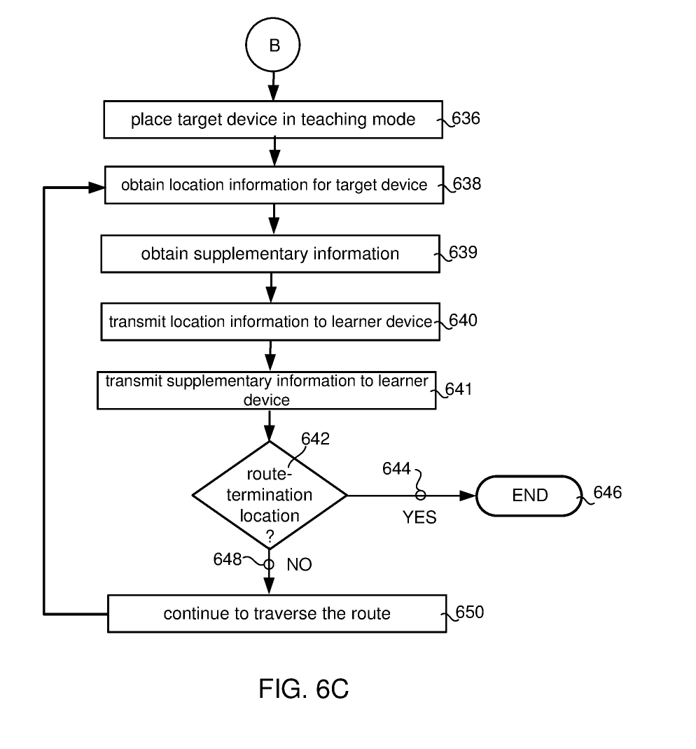

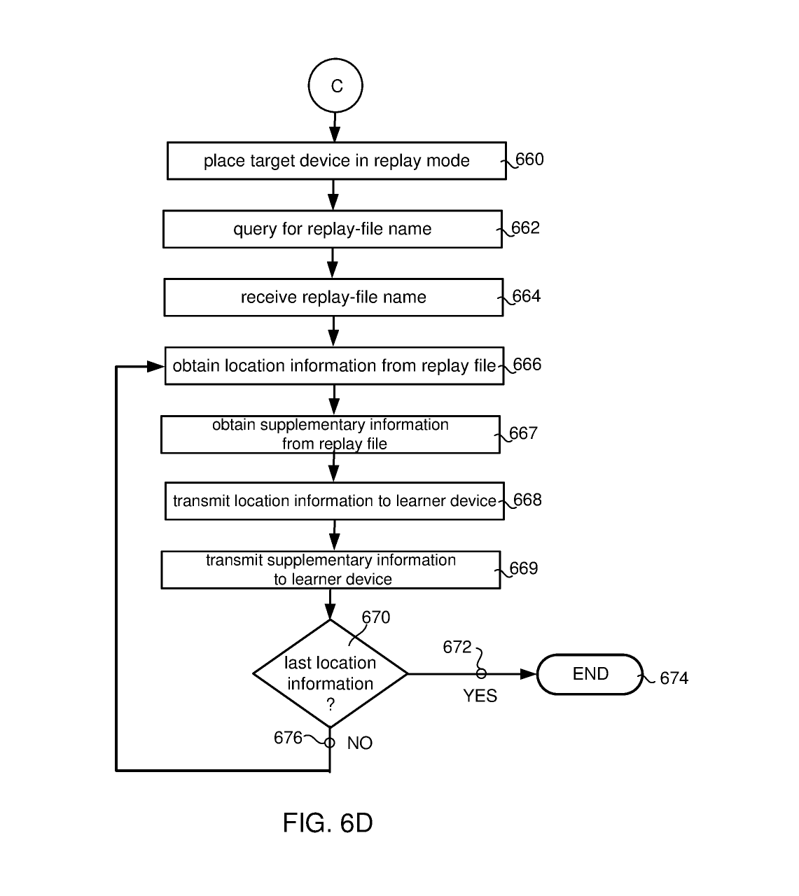

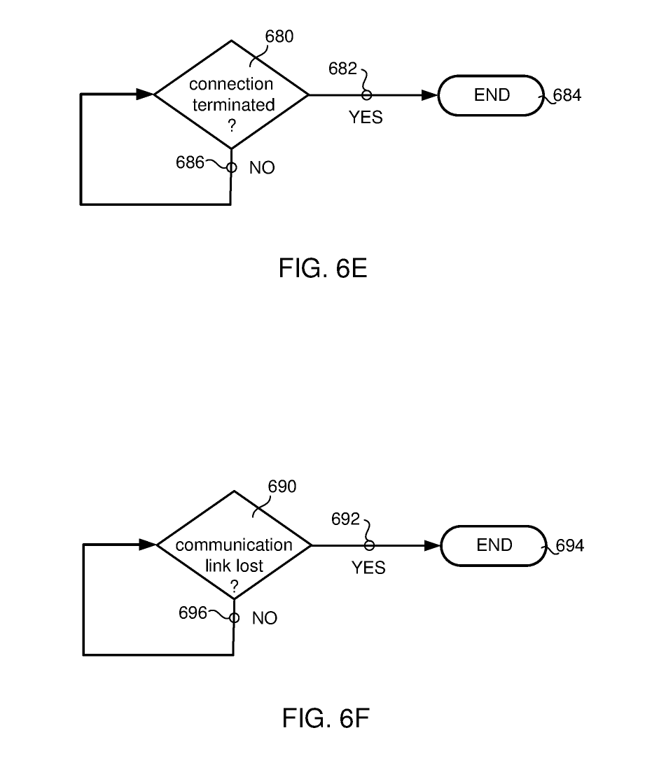

Some embodiments of the present invention, described in relation to FIGS. 6A-6F, may comprise a method 600 by which a target device may define a path to be traversed by a learner device. The target device may receive 602 a request to perform a route-instruction operation. The request may be from a learner device, a request generated at the target device or a request generated at a remote computing device. The target device may query 604, the device from which the request was sent, for an operation mode. The target device may receive 606 the operation mode from the device from which the request was made.

A determination may be made 608 to determine the requested operation mode. If the operation mode is 610 a “store” mode, then the target device may be placed 612 in the recording mode. The current location of the target device may be obtained 614. Associated supplementary information may be obtained 615. The current location information for the target device may be stored 616, and the associated supplementary information may be stored 617. In some embodiments of the present invention, the location information and the supplementary information may be stored on the target device or on a server or other non-local storage.

A determination 618 may be made to determine if the target device is at the route-termination location. If the target is 620 at the route-termination location, then the method 600 may end 622. In some embodiments of the present invention, the ending 622 of the method 600 may comprise storing a route-termination flag, or other indicator.

If the target device is not 624 at the route-termination location, then the target device may continue to traverse 626 the route, and the location information for the current location of the target device may be obtained 614 with the method 600 continuing from there. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms.

If the operation mode is not 630 the “store” mode, then a determination 632 may be made to determine if the operation mode is the “live” mode. If the operation mode is 634 the “live” mode, then the target device may be placed 636 in teaching mode, and the location information for the current location of the target device may be obtained 638, and the associated supplementary information may be obtained 639. The location information for the current location of the target device may be transmitted 640 to the learner device, and the supplementary information may be transmitted 641 to the learner device.

A determination 642 may be made to determine if the target device is 644 at the route-termination location. If the target is 644 at the route-termination location, then the method 600 may end 646. In some embodiments of the present invention, the ending 646 of the method 600 may comprise transmitting a route-termination flag, or other indicator, to the learner device.

If the target device is not 648 at the route-termination location, then the target device may continue to traverse 650 the route, and the location information for the current location of the target device may be obtained 638 and the supplementary information may be obtained 639 and the method 600 may continue from there. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms.

If the operation mode is not 652 the “live” mode, then a determination 654 may be made to determine if the operation mode is the “replay” mode. If the operation mode is 656 the “replay” mode, then the target device may be placed 660 in replay mode, and the target device may query 662 the requesting device for a replay-file name. The target device may receive 664 the replay-file name and obtain 666 location information from the replay file and obtain 667 associated supplementary information from the replay file. The obtained location information may be transmitted 668 to the learner device, and the obtained supplementary information may be transmitted 669.

A determination 670 may be made to determine if the location information is 672 the last available location information in the replay file. If the location information is 672 the last available location information in the replay file, then the method 600 may end 674. In some embodiments of the present invention, the ending 674 of the method 600 may comprise transmitting a route-termination flag, or other indicator, to the learner device.

If the location information is not 676 the last available location information in the replay file, then the target device may obtain 666 the next location information from the replay file, and the method 600 may continue. In some embodiments of the present invention, the location information may be replayed at a set frequency. In some embodiments of the present invention, the set frequency may be communicated from the target device to the learner device. In alternative embodiments, the learner device may communicate to the target device a frequency at which the learner device desires to receive the location information. In still alternative embodiments of the present invention, the target device may wait for a transmit request from the learner device.

If the mode is “live” or “replay”, the target device may monitor to determine 680 if the connection between the target device and the learner device has been terminated by the learner device. If the connection has 682 terminated, then the method 600 may end 684. If the connection has not 686 terminated, the monitoring of connection termination may continue.

If the mode is “live” or “replay,” the target device may monitor to determine 690 if the communication link between the learner device and the target device has been lost. If the communication link has 692 been lost, then the method 600 may end 694. If the communication link has not 696 been lost, then the monitoring of communication link integrity may continue.

If the operation mode is not 698 the “replay” mode, then the method 600 may terminate 699 with an error communication.

In some embodiments of the present invention, a learner device may not track a target device from directly behind the target device. An offset may be required if the target device and the learner device are not able to traverse the same, or similar terrain, for example, the target device may navigate on land and the learner device may navigate on water. In such a situation, it may be desirable to define a path in a river or lake while moving along the shoreline. In other examples, a device on a surface may be a target device for a learner device submerged under the surface, for example, a boat target device and a submergible learner device or a land-surface target device and a sub-terrain learner device, for example, in a drilling application. In such situations, initially establishing a spatial relationship between the target device and the learner device and maintaining that relationship as the target device traverses a path may be desirable.

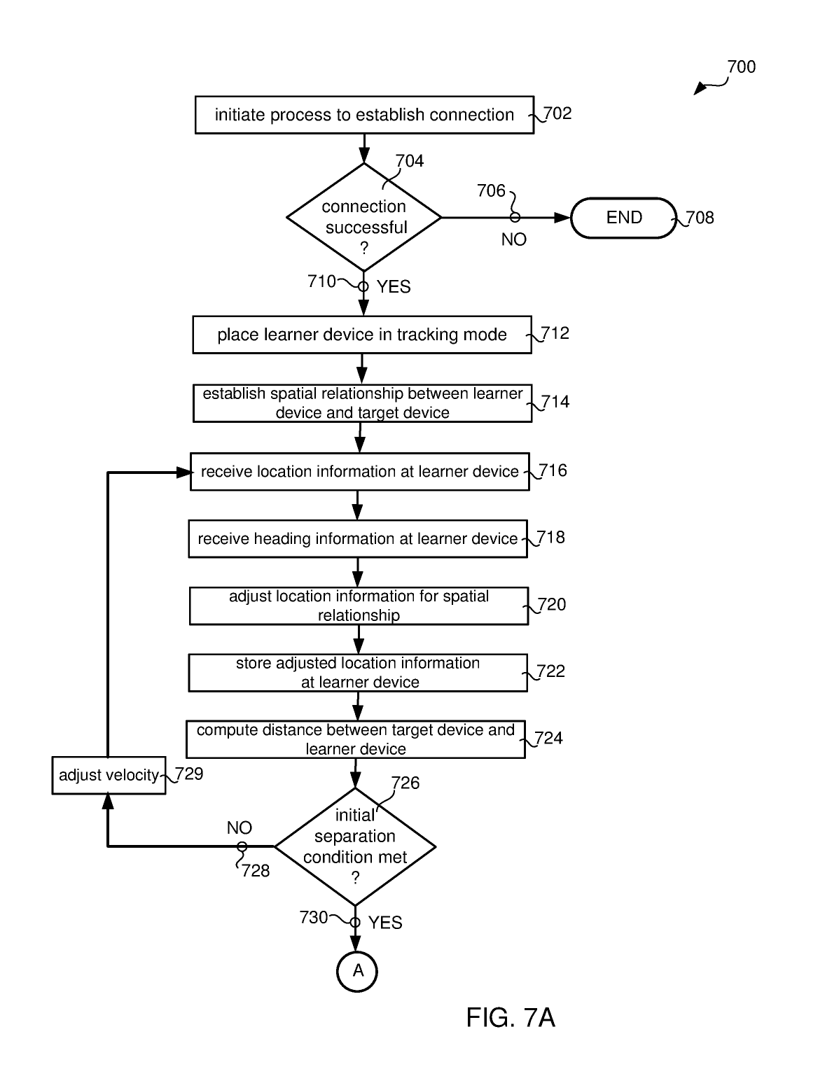

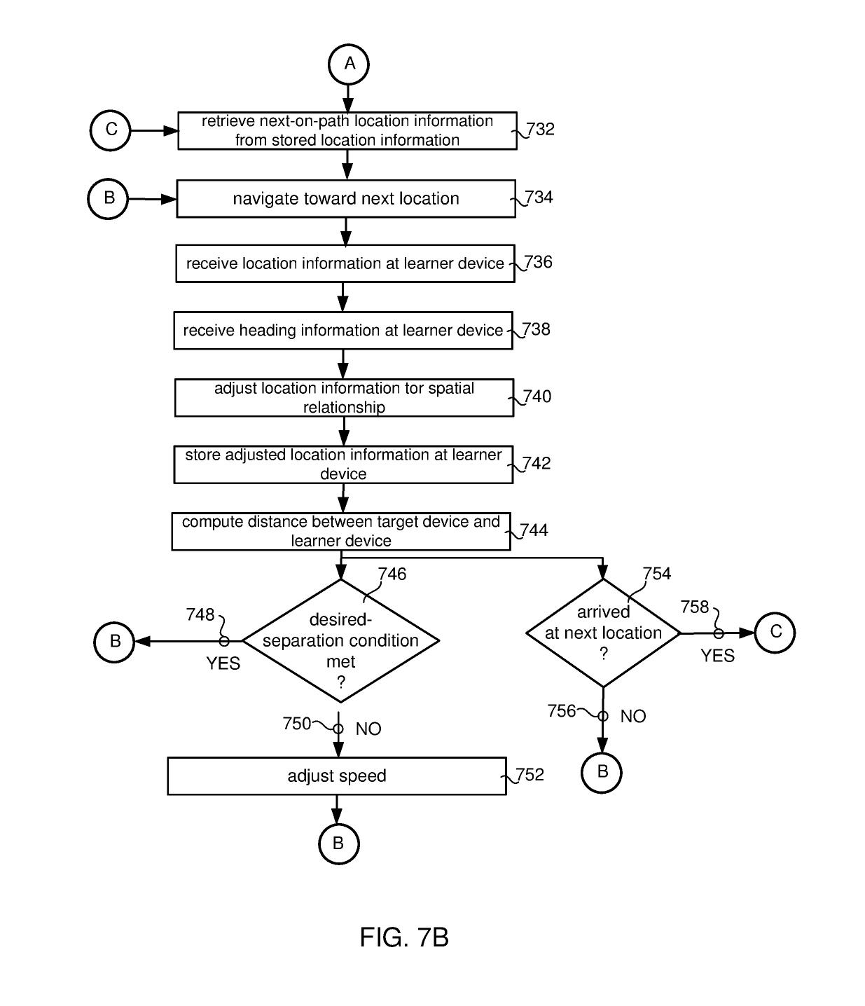

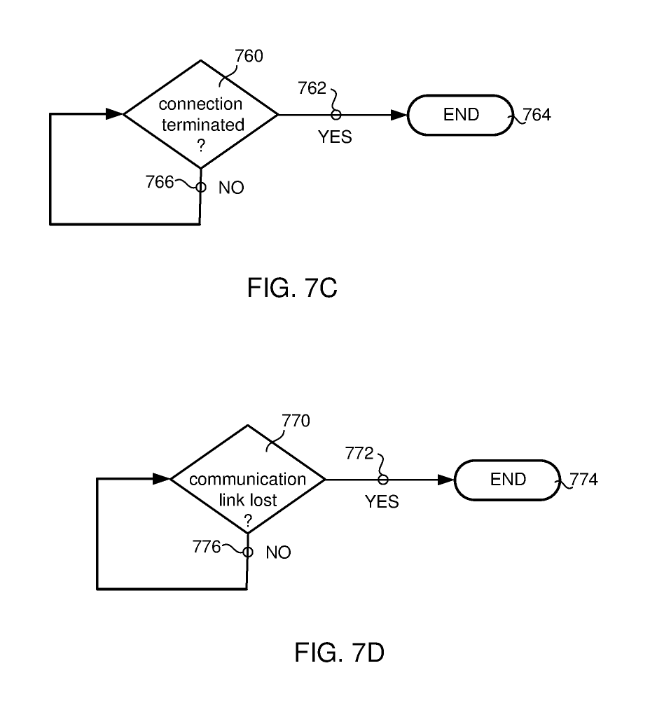

Some embodiments of the present invention, described in relation to FIGS. 7A-7D, may comprise a method 700, also referred to as a route-instruction operation, by which a learner device may track a target device and traverse a path defined by the target device in a situation as described above. In some embodiments of the present invention, the learner device may track the target device from behind the target device. This may be referred to as “pull” tracking. In alternative embodiments of the present invention, the learner device may track the target device from in front of the target device. This may be referred to as “push” tracking.

Either the learner device or the target device may initiate a connection process to establish 702 a connection with the other device. A determination may be made 704 as to whether, or not, the connection was successfully established. If the connection was not 706 successfully established, for example, due to privilege issues, communication link issues, power issues and other reasons for connection failure, the method 700 may terminate 708. In alternative embodiments, not shown, if the connection was not 706 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish 702 a connection between the learner device and the target device may comprise an authentication process to verify that the target device and the learner device each have sufficient privileges to participate in the route-instruction operation 700. In these exemplary embodiments, if either device is not authorized to participate in the route-instruction operation, the connection may not 706 be successfully established, and the method 700 may terminate 708.

If a connection is 710 successfully established between the learner device and the target device, then the learner device may be placed 712 in tracking mode and a spatial relationship between the learner device and the tracker device may be established 714. The learner device may receive 716 location information from the target device, and the learner device may receive 718 heading information from the target device. The heading information and the spatial relationship between the tracking device and the learner device may be used to adjust 720 the received location information to produce learner-device-path location information, corresponding to the received location information, that maintains the desired spatial relationship between the learner device and the target device. The learner device may store 722 the adjusted location information and compute 724 the distance between the target device and the learner device.

A determination may be made 726 as to whether, or not, an initial separation condition between the learner device and the target device is met.

The initial separation condition may be based on a desired amount of initial separation between the learner device and the target device. In some embodiments of the present invention, the desired amount of initial separation may be an initial distance range in which the computed distance is desired to fall. In some embodiments of the present invention, the determination may comprise comparison of the computed distance with a maximum-separation threshold and a minimum-separation threshold. In some embodiments, the maximum-separation threshold may be a fixed, pre-defined value. In alternative embodiments, the maximum-separation threshold may be dependent on other constraints, for example, environmental conditions, target-device speed, transmission-link strength and other constraints. In some embodiments, the minimum-separation threshold may be a fixed, pre-defined value. In alternative embodiments, the minimum-separation threshold may be dependent on other constraints, for example, environmental conditions, target-device speed, transmission-link strength and other constraints.

In some alternative embodiments of the present invention, only a minimum separation may be desired.

In other alternative embodiments of the present invention, only a maximum separation may be desired.

If the initial separation condition is not 728 met, then the learner device may adjust 729 its velocity to effectuate the desired separation. The learner device may continue to: receive 716 location information from the target device; receive 718 heading information from the target device; adjust 720 the received location information to produce learner-device-path location information, corresponding to the received location information, that maintain the desired spatial relationship between the learner device and the target device; store 722 the adjusted location information; and compute 724 the distance between the target device and the learner device until the initial separation condition 730 is met.

If the initial separation condition is 730 met, then the next-on-path location information relative to the learner device's current location may be retrieved 732 from the stored location information, and the learner device may navigate 734 toward a location, also referred to as the next location, defined by these most-recently-retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 734 toward a location defined by the most-recently-retrieved location information.

While navigating to the location defined by the most-recently-retrieved location information, the learner system may continue to: receive 736 location information from the target device; receive 738 heading information from the target device; adjust 740 the received location information to produce learner-device-path location information, corresponding to the received location information, that maintain the desired spatial relationship between the learner device and the target device; store 742 the adjusted location information; and compute 744 the distance between the target device and the learner device.

A determination may be made 746 as to whether, or not, a desired-separation condition is met. In some embodiments of the present invention, the method of determination 746 of whether, or not, the desired-separation condition is met made when the learner device is navigating may be the same as the method of determination 726 of whether, or not, the initial separation condition is met made when the learner device is initially beginning to track the target device. In alternative embodiments, the method of determination 746 of whether, or not, the desired-separation condition is met made when the learner device is navigating may be a different method than the method of determination 726 of whether, or not, the initial separation condition is met made when the learner device is initially beginning to track the target device.

If the desired-separation condition is 748 met, then the learner device may continue to: navigate 734 to the location defined by the most-recently-retrieved location information; receive 736 location information from the target device; receive 738 heading information from the target device; adjust 740 the received location information to produce learner-device-path location information, corresponding to the received location information, that maintain the desired spatial relationship between the learner device and the target device; store 742 the adjusted location information; and compute 744 the distance between the target device and the learner device.

If the desired-separation condition 750 is not met, then the learner device may adjust 752 its velocity accordingly in an effort to maintain the desired separation, while then continuing to: navigate 734 to the location defined by the most-recently-retrieved location information, to receive 736 location information from the target device; receive 738 heading information from the target device; adjust 740 the received location information to produce learner-device-path location information, corresponding to the received information, that maintain the desired spatial relationship between the learner device and the target device; store 742 the adjusted coordinates; and compute 744 the distance between the target device and the learner device.

The learner device may monitor to determine 754 if the learner device has arrived at the next location. If the learner device has not 756 arrived at the next location, then the learner device may continue to: navigate 734 to the next location; receive 736 location information from the target device; receive 738 heading information from the target device; adjust 740 the received location information to produce learner-device-path information, corresponding to the received location information, that maintain the desired spatial relationship between the learner device and the target device; store 742 the adjusted location information; and compute 744 the distance between the target device and the learner device.

If the learner device has 758 arrived at the next location, then learner device may retrieve 732 the next-on-path location information relative to the learner device's current location from the stored location information, and the method 700 may continue.

The learner device may monitor to determine 760 if the connection between the target device and the learner device has been terminated by the target device. If the connection has 762 terminated, then the method 700 may end 764. If the connection has not 766 terminated, the monitoring of connection termination may continue.

The learner device may monitor to determine 770 if the communication link between the learner device and the target device has been lost. If the communication link has 772 been lost, then the method 700 may end 774. If the communication link has not 776 been lost, then the monitoring of communication link integrity may continue.

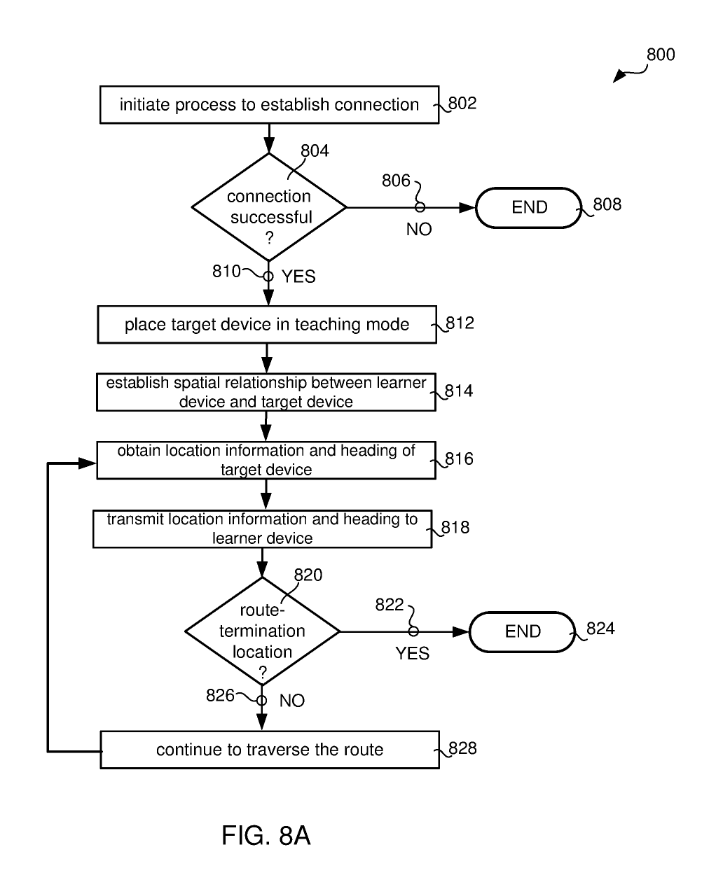

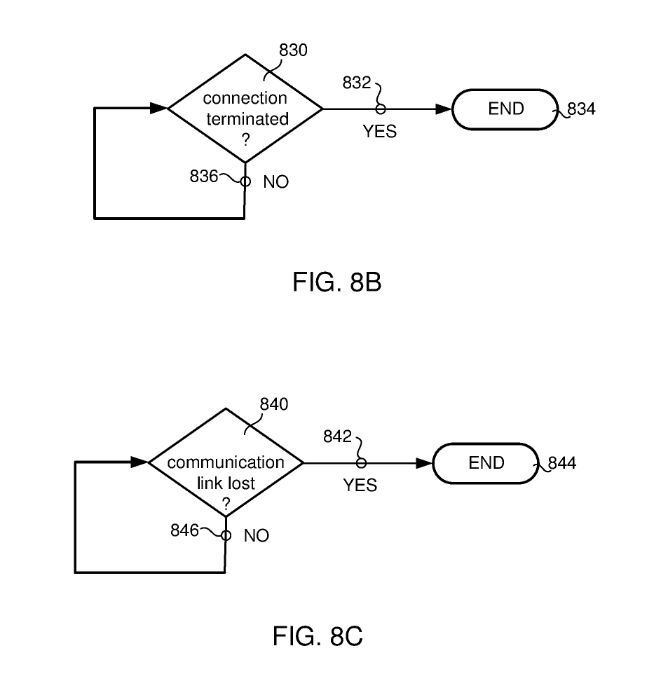

Some embodiments of the present invention, described in relation to FIG. 8A-8C, may comprise a method 800 by which a target device may define a path to be traversed by a learner device. Either the learner device or the target device may initiate a connection process to establish 802 a connection with the other device. A determination may be made 804 as to whether, or not, the connection was successfully established. If the connection was not 806 successfully established, for example, due to privilege issues, communication link issues, power issues and other reasons for connection failure, the method 800 may terminate 808. In alternative embodiments, not shown, if the connection was not 806 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish 802 a connection between the learner device and the target device may comprise an authentication process to verify that the target device and the learner device each have sufficient privileges to participate in the route-instruction operation 800. In these exemplary embodiments, if either device is not authorized to participate in the route-instruction operation, the connection may not 806 be successfully established, and the method 800 may terminate 808.

If a connection is 810 successfully established between the learner device and the target device, then the target device may be placed 812 in teaching mode and a spatial relationship between the learner device and the tracker device may be established 814. The location information for the current location of the target device and the current heading of the target device may be obtained 816. The location information for the current location of the target device and the current heading of the target device may be transmitted 818 to the learner device.

A determination 820 may be made to determine if the target device is 822 at the route-termination location. If the target is 822 at the route-termination location, then the method 800 may end 824. In some embodiments of the present invention, the ending 824 of the method 800 may comprise transmitting a route-termination flag, or other indicator, to the learner device.

If the target device is not 826 at the route-termination location, then the target device may continue to traverse 828 the route, and the location information for the current location of the target device and the current heading of the target device may be obtained 916. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms.

The target device may monitor to determine 830 if the connection between the target device and the learner device has been terminated by the learner device. If the connection has 832 terminated, then the method 800 may end 834. If the connection has not 836 terminated, the monitoring of connection termination may continue.

The target device may monitor to determine 840 if the communication link between the learner device and the target device has been lost. If the communication link has 842 been lost, then the method 800 may end 844. If the communication link has not 846 been lost, then the monitoring of communication link integrity may continue.

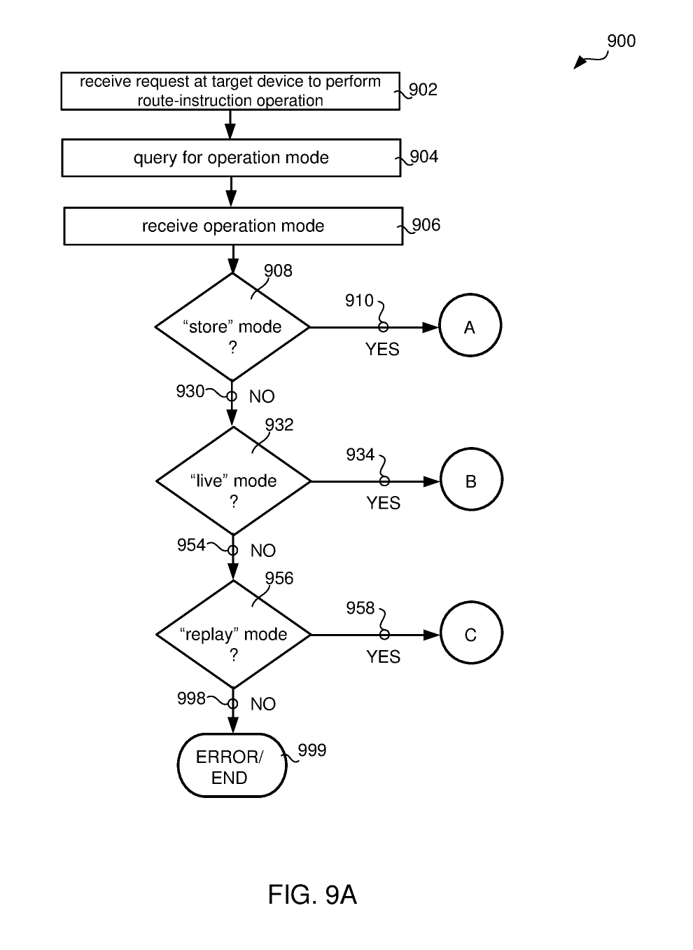

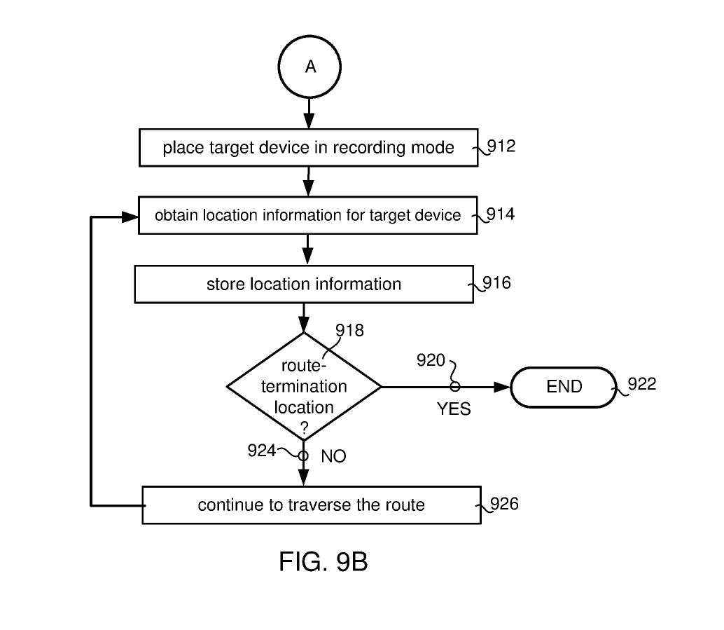

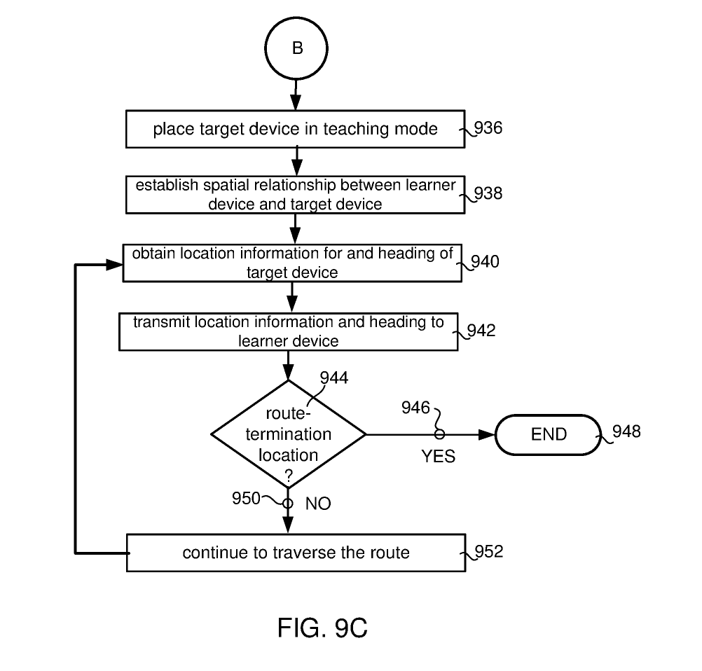

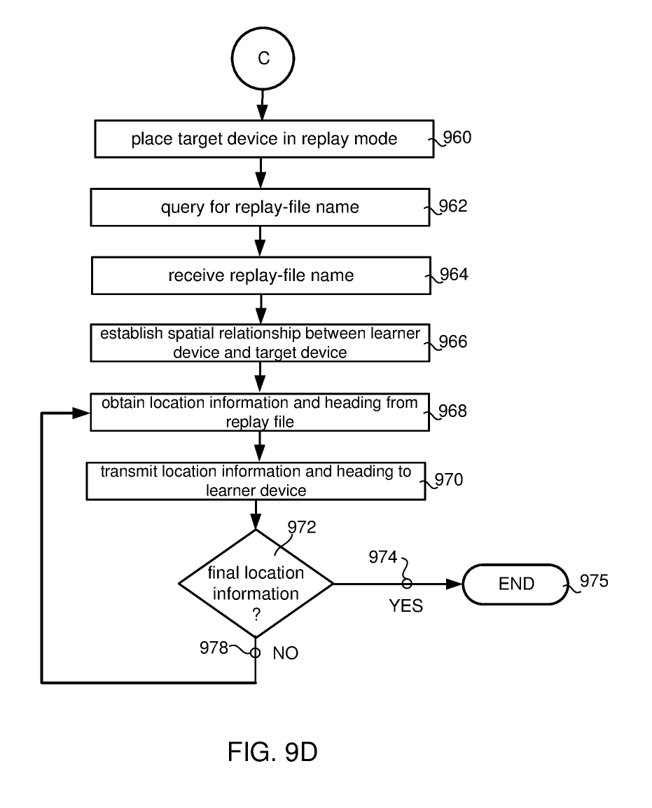

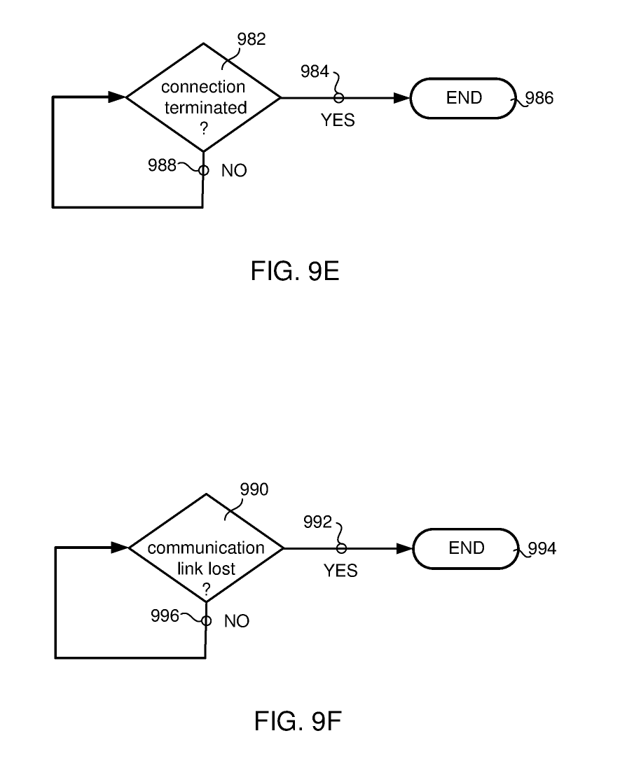

Some embodiments of the present invention, described in relation to FIG. 9A-9F, may comprise a method 900 by which a target device may define a path to be traversed by a learner device. The target device may receive 902 a request to perform a route-instruction operation. The request may be from a learner device, a request generated at the target device or a request generated at a remote computing device. The target device may query 904, the device from which the request was sent, for an operation mode. The target device may receive 906 the operation mode from the device from which the request was made.

A determination may be made 908 to determine if the requested operation mode is a “store” mode. If the operation mode is 910 the “store” mode, then the target device may be placed 912 in the recording mode. The current location of the target device may be obtained 914. The location information of the current location of the target device may be stored 916. In some embodiments of the present invention, the location information may be stored on the target device or on a server or other non-local storage.

A determination 918 may be made to determine if the target device is at the route-termination location. If the target is 920 at the route-termination location, then the method 900 may end 922. In some embodiments of the present invention, the ending 922 of the method 900 may comprise storing a route-termination flag, or other indicator.

If the target device is not 924 at the route-termination location, then the target device may continue to traverse 926 the route, and the location information of the current location of the target device may be obtained 914, and the method 900 may continue. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms.

If the operation mode is not 930 the “store” mode, then a determination 932 may be made to determine if the operation mode is the “live” mode. If the operation mode is 934 the “live” mode, then the target device may be placed 636 in teaching mode and a spatial relationship between the learner device and the target device may be established 938. The location information for the current location of the target device and the current heading of the target device may be obtained 940 and transmitted 942 to the learner device.

A determination 944 may be made to determine if the target device is 946 at the route-termination location. If the target is 946 at the route-termination location, then the method 900 may end 948. In some embodiments of the present invention, the ending 948 of the method 900 may comprise transmitting a route-termination flag, or other indicator, to the learner device.

If the target device is not 950 at the route-termination location, then the target device may continue to traverse 952 the route. The location information for the current location of the target device and the current heading of the target device may be obtained 940, and the method 900 may continue. In some embodiments of the present invention, the location information may be obtained at a set frequency. In alternative embodiments of the present invention, an operator may request that location information be obtained by interacting with the target device through a user input, for example, a button push, a menu selection, activation of a trigger and other user input mechanisms.

If the operation mode is not 954 the “live” mode, then a determination 956 may be made to determine if the operation mode is the “replay” mode. If the operation mode is 958 the “replay” mode, then the target device may be placed 960 in teaching mode, and the target device may query 962 the requesting device for a replay-file name. The target device may receive 964 the replay-file name. A spatial relationship between the learner device and the target device may be established 966. Location information and a heading may be obtained 968 from the replay file. The obtained location information and heading may be transmitted 970.

A determination 972 may be made to determine if the final location information and heading have been retrieved from the replay file. If the final coordinates and heading have been 974 retrieved at the route-termination location, then the method 900 may end 975. In some embodiments of the present invention, the ending 975 of the method 900 may comprise transmitting a route-termination flag, or other indicator, to the learner device.

If final location information and heading have not been received 978, then the target device may obtain 968 the next location information from the replay file, and the method 900 may continue. In some embodiments of the present invention, the location information may be replayed at a set frequency. In some embodiments of the present invention, the set frequency may be communicated from the target device to the learner device. In alternative embodiments, the learner device may communicate to the target device a frequency at which the learner device desires to receive the location information. In still alternative embodiments of the present invention, the target device may wait for a transmit request from the learner device.

The target device may monitor to determine 982 if the connection between the target device and the learner device has been terminated by the learner device. If the connection has 984 terminated, then the method 900 may end 986. If the connection has not 988 terminated, the monitoring of connection termination may continue.

The target device may monitor to determine 990 if the communication link between the learner device and the target device has been lost. If the communication link has 992 been lost, then the method 900 may end 994. If the communication link has not 996 been lost, then the monitoring of communication link integrity may continue.

If the operation mode is not 998 the “replay” mode, then the process may terminate 999 with an error communication.

Some embodiments of the present invention may be described in relation to FIG. 10. A target-learner system 1000 may comprise a learner device 1002 capable of navigating a route, also referred to as a path. Exemplary learner devices include autonomous navigation vehicles, robots and other learner devices. The learner device 1002 may comprise one, or more, on-board sensor(s) 1004 for sensing environmental and/or surrounding conditions, one, or more, navigation devices 1006 for providing and analyzing navigation-related information, one, or more, control systems 1008 for effectuating controlled movement of the learner device, a receiving/transmitting component 1010 for receiving location information and transmitting location and sensor information and a memory 1012 for storing location and sensor information.

The target-learner system 1000 may further comprise a target device 1014 comprising a collection component 1016 for collecting location information, a recording component 1018 for recording the location information and a transmitting component 1020 for transmitting the location information and sensor information, obtained by one, or more, on-board sensor(s) 1022, to a server system 1024. Exemplary location information may include longitude and latitude information, for example, GPS coordinates and other longitude and latitude information, displacement and heading information relative to fixed location and other location information.

The target-learner system may further comprise a server system 1024. The server system 1024 may comprise a receiving component 1026 for receiving location information and sensor information from the target system 1014 and the learner system 1002 and a transmitting component 1028 for transmitting location information to the learner device 1002. The server system 1024 may further comprise a memory 1030 for storing information and a processor 1032 for processing information according to embodiments herein.

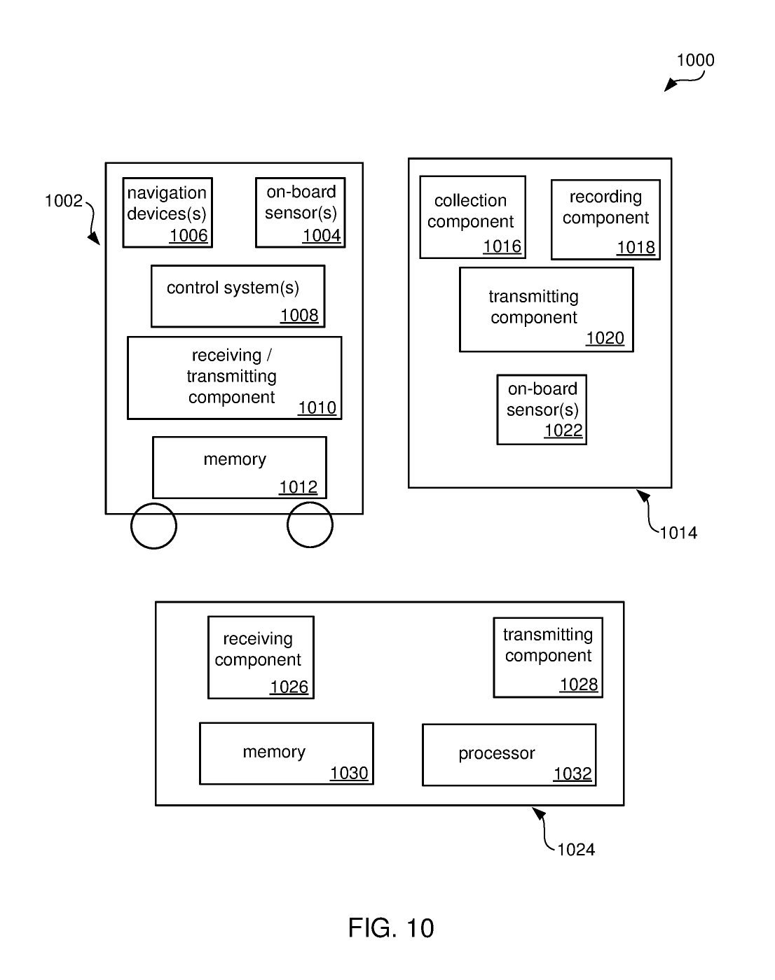

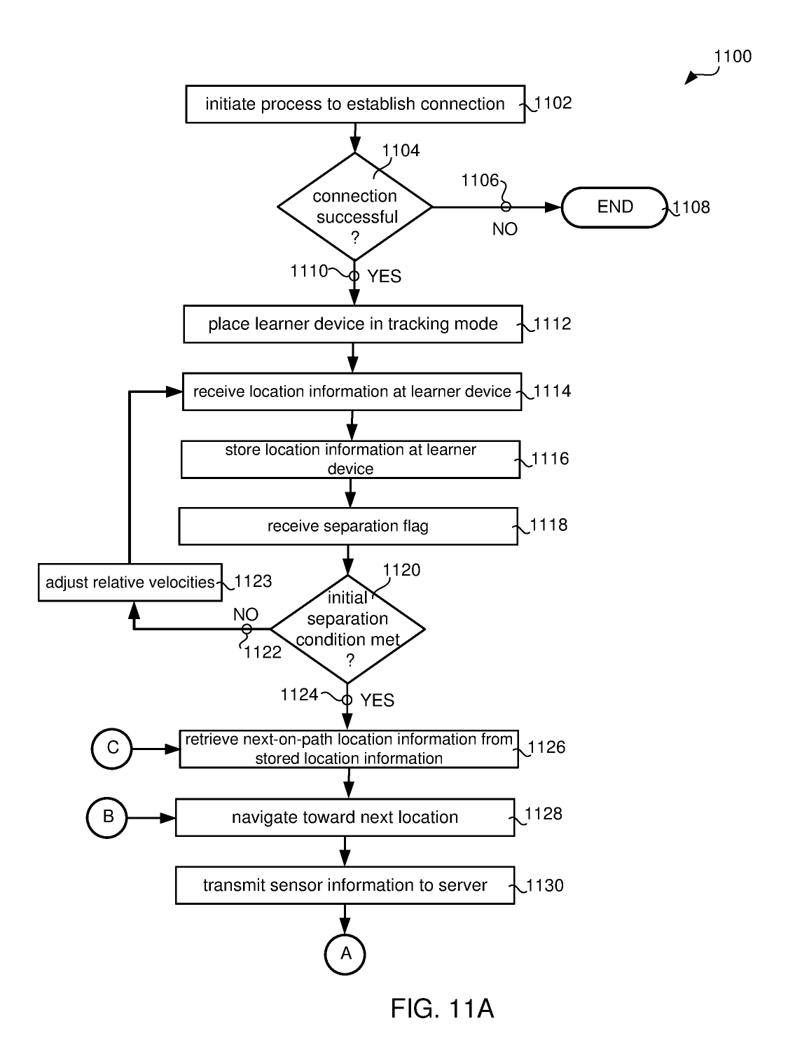

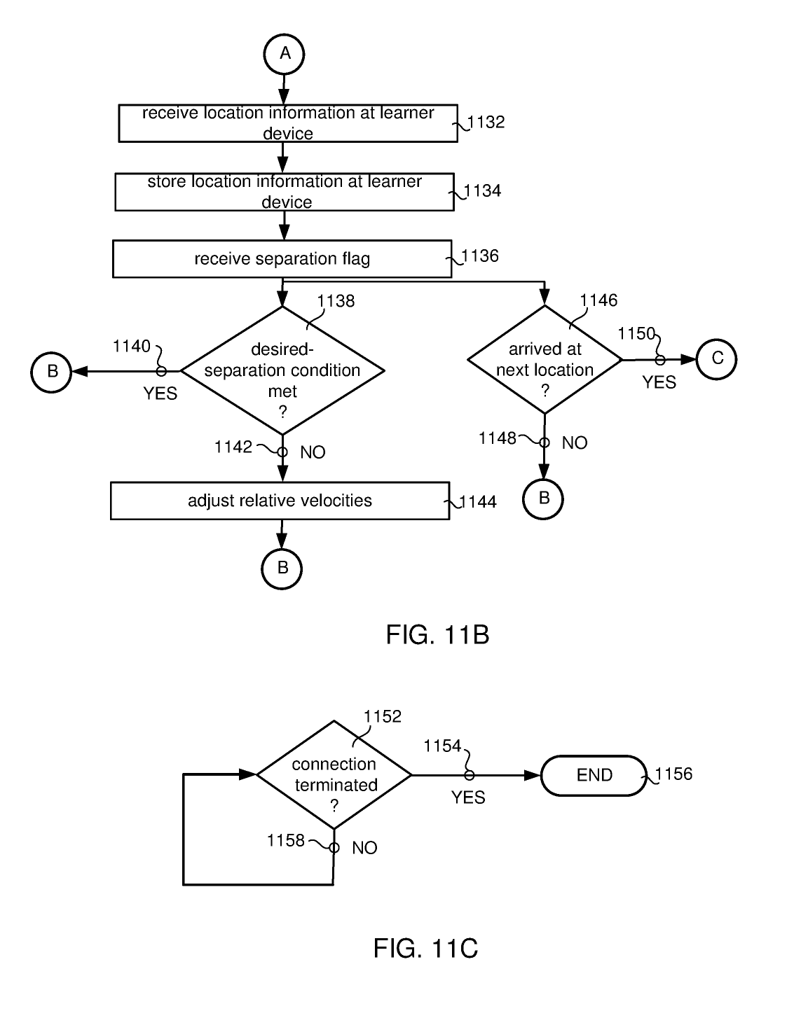

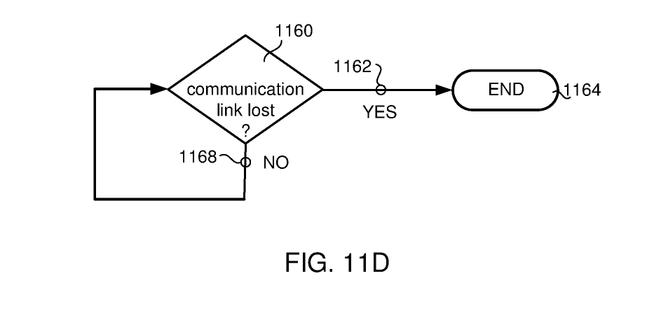

Some embodiments of the present invention, described in relation to FIGS. 11A-11D, may comprise a method 1100, also referred to as a route-instruction operation, by which a learner device may track a target device and traverse a path defined by the target device in a situation as described above. In some embodiments of the present invention, the learner device may track the target device from behind the target device. This may be referred to as “pull” tracking. In alternative embodiments of the present invention, the learner device may track the target device from in front of the target device. This may be referred to as “push” tracking.

Either the learner device or the target device may initiate 1102 a connection process to establish a connection with the other device via a server system. A determination may be made 1104 as to whether, or not, the connection was successfully established. If the connection was not 1106 successfully established, for example, due to privilege issues, communication link issues, power issues and other reasons for connection failure, the method 1100 may terminate 1108. In alternative embodiments, not shown, if the connection was not 1106 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish a connection between the learner device and the target device via the server system may comprise an authentication process to verify that the target device and the learner device each have sufficient privileges to participate in the route-instruction operation 1100. In these exemplary embodiments, if either device is not authorized to participate in the route-instruction operation, the connection may not 1106 be successfully established, and the method 1100 may terminate 1108.

If a connection is 1110 successfully established between the learner device and the target device, then the learner device may be placed 1112 in tracking mode. The learner device may receive 1114 location information, from the server system, describing a learner-device route location describing a location on the route the learner device must travel to maintain a desired relationship to the target device. The learner device may store 1116 the location information. The learner device may receive 1118 a separation flag indicating whether, or not, the distance between the target device and the learner device meets an initial separation condition. A determination may be made 1120 as to whether, or not, the initial separation, between the learner device and the target device, is met. The determination may comprise examination of the separation flag.

If the initial separation condition is not 1122 met, then the relative velocities of the target device and the learner device may be adjusted 1123 to effectuation the initial separation. Then the learner device may continue to: receive 1114 location information from the target device; store 1116 the location information; and receive 1118 the separation flag until the initial separation condition is 1124 met.

If the initial separation condition is 1124 met, then the next-on-path location information, relative to the learner device's current location, may be retrieved 1126 from the stored location information, and the learner device may navigate 1128 toward a location defined by the most-recently-retrieved location information. One of ordinary skill in the art will appreciate a multitude of autonomous navigation algorithms, for example, pure pursuit path tracking and other algorithms known in the art, available to be used to provide a navigation capability to effectuate the learner-device navigation 1128 toward a location defined by the most-recently-retrieved location information, also referred to as the next location.

While navigating 1128 to the location defined by the most-recently-retrieved location information, the learner system may transmit 1130 sensor information to the server system, and the learner system may continue to receive 1132 location information, to store 1134 the received location information and to receive 1136 the separation flag.

A determination may be made 1138 as to whether, or not, a desired-separation condition is met. The separation flag may be examined to determine if the desired-separation condition is met.

If the desired-separation condition is 1138 met, then the learner device may continue to: navigate 1128 to the location defined by the most-recently-retrieved location information; transmit 1130 sensor information; receive 1132 and store 1134 location information; and receive 1136 the separation flag.

If the desired-separation condition is not 1140 met, then the learner device may adjust 1144 its velocity accordingly in an effort to maintain the desired separation. In alternative embodiments (not shown), the target device and the learner device may communicate their respective positions, headings and speed to the server, and the server may determine jointly optimal velocity changes for each device to maintain the desired separation. The learner device may continue to: to navigate 1128 to the location defined by the most-recently-retrieved location information; receive 1132 location information; transmit 1130 sensor information; store 1134 location information; and receive 1126 the separation flag.

The learner device may monitor to determine 1146 if the learner device has arrived at the location defined by the most-recently-retrieved location information.

If the learner device has not 1148 arrived at the location defined by the most-recently-retrieved location information, then the learner device may continue to: navigate 1128 to the location defined by the most-recently-retrieved location information; transmit 1130 sensor information; receive 1132 location information; store 1134 location information; and receive 1136 the separation flag.

If the learner device has 1150 arrived at the location defined by the most-recently-retrieved location information, then learner device may retrieve 1126 the next-on-path location information, relative to the learner device's current location, from the stored location information, and the method 1100 may continue.

The learner device may monitor to determine 1152 if the connection between the learner device and the server system has been terminated by the server system. If the connection has 1154 terminated, then the method 1100 may end 1156. If the connection has not 1158 terminated, the monitoring of connection termination may continue.

The learner device may monitor to determine 1160 if the communication link between the learner device and the target device has been lost. If the communication link has 1162 been lost, then the method 1100 may end 1164. If the communication link has not 1166 been lost, then the monitoring of communication link integrity may continue.

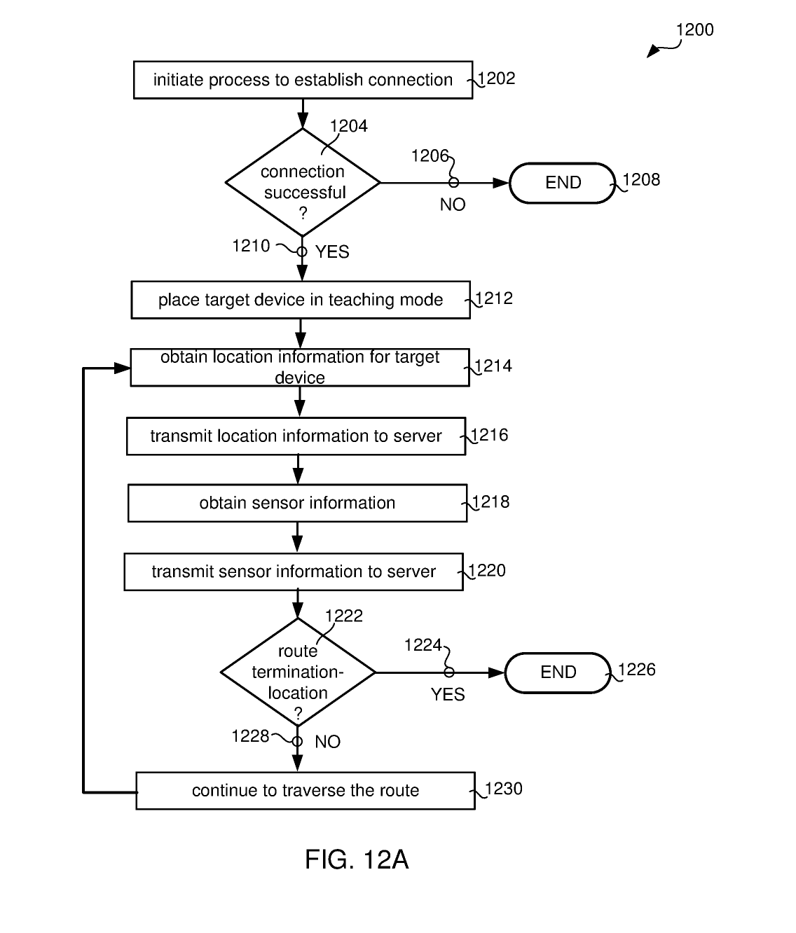

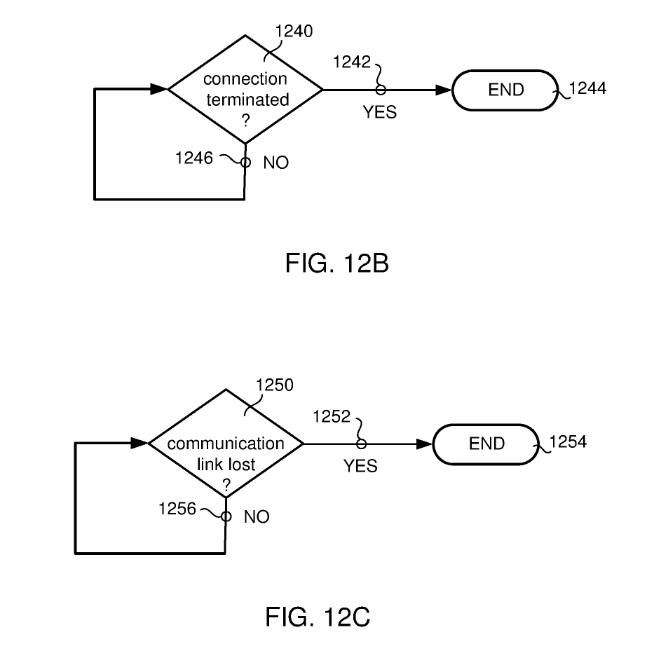

Some embodiments of the present invention, described in relation to FIG. 12A-12C, may comprise a method 1200 by which a target device may define a path to be traversed by a learner device. Either the learner device or the target device may initiate 1202 a connection process to establish a connection with the other device via a server system. A determination may be made 1204 as to whether, or not, the connection was successfully established. If the connection was not 1206 successfully established, for example, due to privilege issues, communication link issues, power issues and other reasons for connection failure, the method 1200 may terminate 1208. In alternative embodiments, not shown, if the connection was not 1206 successfully established, additional attempts to establish the connection may be performed until a termination condition is met, for example, a pre-defined, fixed number of attempts have been made, a timeout occurs, the requesting device withdraws the request and other termination conditions.

In some embodiments of the present invention, the connection process to establish a connection between the learner device and the target device may comprise an authentication process to verify that the target device and the learner device each have sufficient privileges to participate in the route-instruction operation 1200. In these exemplary embodiments, if either device is not authorized to participate in the route-instruction operation, the connection may not 1206 be successfully established, and the method 1200 may terminate 1208.

If a connection is 1210 successfully established between the learner device and the target device, then the target device may be placed 1212 in teaching mode, and location information describing the current location of the target device may be obtained 1214. The location information for the current location of the target device may be transmitted 1216 to the server system. Sensor information may be obtained 1218 from the onboard sensors, and the sensor information may be transmitted 1220 to the server system.

A determination 1222 may be made to determine if the target device is at the route-termination location. If the target is 1224 at the route-termination location, then the method 1200 may end 1226. In some embodiments of the present invention, the ending 1226 of the method 1200 may comprise transmitting a route-termination flag, or other indicator, to the server system.

If the target device is not 1228 at the route-termination location, then the target device may continue to traverse 1230 the route, and the location information for the current location of the target device may be obtained 1214 and the method may continue as described above. In some embodiments of the present invention, the location information and sensor information may be obtained at a set frequency. In alternative embodiments of the present invention, an operator may request that location information and/or sensor information be obtained by interacting with the target device through a user input, for example, a button push, a menu selection, activation of a trigger and other user input mechanisms.

The target device may monitor to determine 1240 if the connection between the target device and the server system has terminated. If the connection has 1242 terminated, then the method 1200 may end 1244. If the connection has not 12466 terminated, the monitoring of connection termination may continue.

The target device may monitor to determine 1250 if the communication link between the server system and the target device has been lost. If the communication link has 1252 been lost, then the method 1200 may end 1254. If the communication link has not 1256 been lost, then the monitoring of communication link integrity may continue.

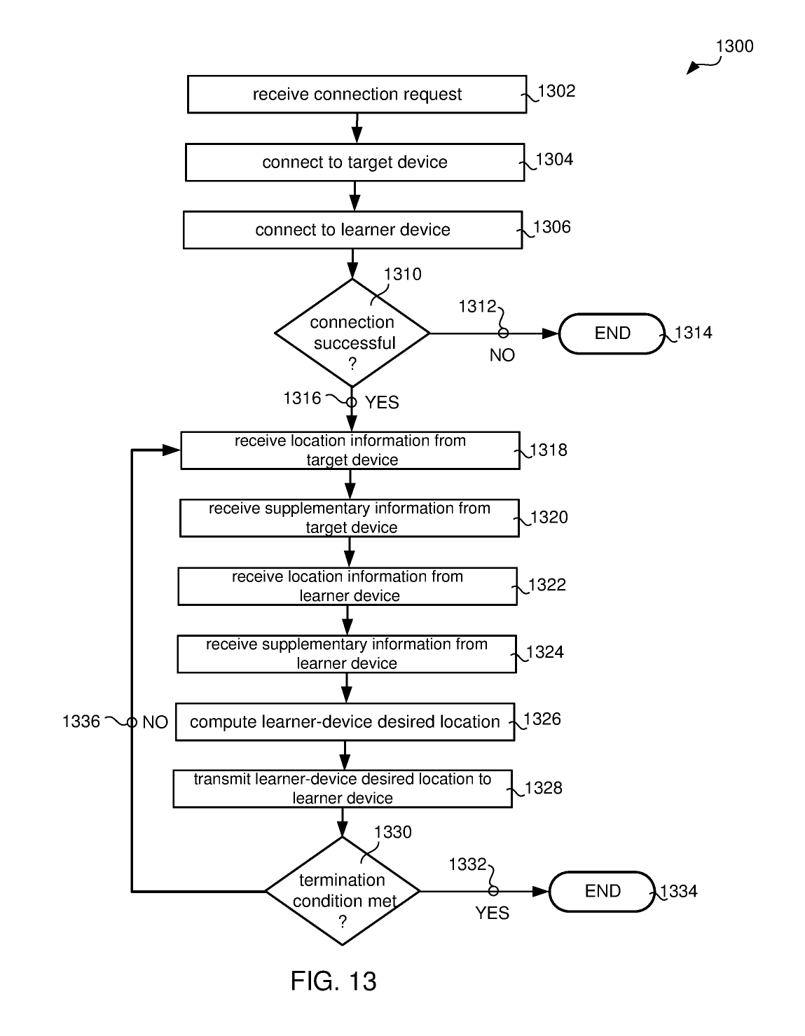

Some embodiments of the present invention, described in relation to FIG. 13, may comprise a method 1300 by which a server system may determine a path for a learner system to traverse based on information received from a target system. The server system may receive 1302 a connection request from either the learner device or the target device. The server system may connect 1304 to the target device, and the server system may connect 1306 to the learner device.

A determination may be made 1310 as to whether, or not, the connections were successfully established. If the connections were not 1312 successfully established, for example, due to privilege issues, communication link issues, power issues and other reasons for connection failure, the method 1300 may terminate 1314. In alternative embodiments, not shown, if the connections were not 1314 successfully established, additional attempts to establish the connections may be performed until a termination condition is met, for example, a pre-defined, fixed number of attempts have been made, a timeout occurs, the requesting device withdraws the request and other termination conditions.

In some embodiments of the present invention, the connection process to establish a connection between the learner device and the server system and the target device and the server system may comprise an authentication process to verify that the target device and the learner device each have sufficient privileges to participate in the route-instruction operation 1300. In these exemplary embodiments, if either device is not authorized to participate in the route-instruction operation, the connections may not 1312 be successfully established, and the method 1300 may terminate 1314.

If the connections are 1316 successfully made, the server system may receive 1318 location information from the target device and may receive 1320 supplementary information from the target device. Examples of supplementary information include information about the environment in which the target and/or learner device(s) may operate, for example, exclusion zones in which travel is not allowed and other operational information, information to augment positional data, for example, visual information, which may be analyzed using image enhancement, reconstruction and understanding methods known in the art, collected by a camera on the target device, environmental information, for example, weather conditions, path conditions and other environment information, which may be used to infer accuracy and other reliability information with respect to the location information, and other supplementary information. Supplementary information may comprise sensor information from the target device's onboard sensors.

The server system may receive 1322 location information from the learner device and may receive 1324 supplementary information from the learner device. Examples of supplementary information include information about the environment in which the target and/or learner device(s) may operate, for example, exclusion zones in which travel is not allowed and other operational information, information to augment positional data, for example, visual information, which may be analyzed using image enhancement, reconstruction and understanding methods known in the art, collected by a camera on the target device, environmental information, for example, weather conditions, path conditions and other environment information, which may be used to infer accuracy and other reliability information with respect to the location information, and other supplementary information. Supplementary information may comprise sensor information from the learner device's onboard sensors.

The server system may compute 1326 a learner-device route location corresponding to the target device location. The server system may use the location information from the target device and the supplementary information from both the learner device and the target device to compute 1326 a learner-device route location.

The server system may transmit 1328 the learner-device route location to the learner device.

A determination may be made 1330 whether, or not, a termination condition is met. If the termination condition is 1332 met, then the process 1300 may end. Exemplary termination conditions include a termination request from either the target device or the learner device, loss of connection between the server system and either the target device or the learner device and other termination conditions.

Embodiments of the present invention may comprise a combination of features from the above-described embodiments of the present invention.

Some embodiments of the present invention may comprise a computer program product comprising a computer-readable storage medium having instructions stored thereon/in which may be used to program a computing system to perform any of the features and methods described herein. Exemplary computer-readable storage media may include, but are not limited to, flash memory devices, disk storage media, for example, floppy disks, optical disks, magneto-optical disks, Digital Versatile Discs (DVDs), Compact Discs (CDs), micro-drives and other disk storage media, Read-Only Memory (ROMs), Programmable Read-Only Memory (PROMs), Erasable Programmable Read-Only Memory (EPROMS), Electrically Erasable Programmable Read-Only Memory (EEPROMs), Random-Access Memory (RAMS), Video Random-Access Memory (VRAMs), Dynamic Random-Access Memory (DRAMs) and any type of media or device suitable for storing instructions and/or data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for tracking a target device, the method comprising:
establishing a connection between a target device and a learner device;
establishing a spatial relationship between the learner device and the target device;
receiving location information, at the learner device, from the target device;
receiving heading information, at the learner device, from the target device;
adjusting the location information for the spatial relationship;
storing the adjusted location information and the heading information at the learner device in a location storage;
computing a distance between the target device and the learner device; and
when the computed distance meets a desired-separation condition:
retrieving a next location information and the associated heading information from the location storage; and
navigating the learner device toward the next location identified by the next location information using the retrieved associated heading information.

2. A method as described in claim 1 further comprising:
when a desired-separation condition is not met:
adjusting the velocity of the learner device to maintain sufficient separation and the spatial relationship.

3. A method as described in claim 1, wherein the spatial relationship between the learner device and the target device is such that the learner device is in front of the target device.

4. A method as described in claim 1, wherein the spatial relationship between the learner device and the target device is such that the learner device is behind the target device.

5. A method as described in claim 1, wherein the spatial relationship between the learner device and the target device is such that the learner device and the target device are not co-linear with the direction of travel.

6. A method as described in claim 1, wherein the spatial relationship between the learner device and the target device is such that the target device is on a water surface and the learner device is submerged relative to the target device.

7. A method as described in claim 1 further comprising receiving supplementary information at the learner device from the target device and using the supplementary information to further adjust the location information.

8. A method as described in claim 7, wherein the supplementary information comprises at least one of environmental information, exclusion zones in which travel is not allowed and visual information.

9. A method as described in claim 1 further comprising receiving supplementary information at the learner device from the target device and using the supplementary information in the navigating.

10. A method as described in claim 9, wherein the supplementary information comprises at least one of environmental information, exclusion zones in which travel is not allowed and visual information.

11. A target-following system comprising:
a learner device;
a target device; and
a server system, wherein the server system operates to:
establish a connection between the learner device and the target device;
receive learner-device location information and associated supplementary information from the learner device;
receive target-device location information and associated supplementary information from the target device;
compute a learner-device desired location corresponding to a target-device location; and
transmit the learner-device desired location to the learner device.

12. A system as described in claim 11, wherein the server system further operates to establish a spatial relationship between the target device; the learner-device desired location is computed to maintain the spatial relationship; and the learner device and the spatial relationship between the learner device and the target device is such that the learner device is in front of the target device.

13. A system as described in claim 11, wherein the server system further operates to establish a spatial relationship between the target device; the learner-device desired location is computed to maintain the spatial relationship; and the learner device and the spatial relationship between the learner device and the target device is such that the learner device is behind the target device.

14. A system as described in claim 11, wherein the server system further operates to establish a spatial relationship between the target device; the learner-device desired location is computed to maintain the spatial relationship; and the spatial relationship between the learner device and the target device is such that the learner device and the target device are not co-linear with the direction of travel.

15. A system as described in claim 11, wherein the server system further operates to establish a spatial relationship between the target device; the learner-device desired location is computed to maintain the spatial relationship; and the spatial relationship between the learner device and the target device is such that the target device is on a water surface and the learner device is submerged relative to the target device.

16. A system as described in claim 11, wherein the server system further operates to compute the distance between the target device and the learner device.

17. A system as described in claim 16, wherein the server system further operates to transmit a separation flag, to the learner device, based on the computed distance between the target device and the learner device.

18. A method for tracking a target device, the method comprising:
establishing a connection between a target device and a learner device;
establishing a spatial relationship between the learner device and the target device;
determining location information describing the location of the target device; and
transmitting location information, from the target device, to the learner device;

19. A method as described in claim 18, wherein the spatial relationship between the learner device and the target device is such that the learner device is in front of the target device.

20. A method as described in claim 18, wherein the spatial relationship between the learner device and the target device is such that the learner device is behind the target device.

21. A method as described in claim 18, wherein the spatial relationship between the learner device and the target device is such that the learner device and the target device are not co-linear with the direction of travel.

22. A method as described in claim 18, wherein the spatial relationship between the learner device and the target device is such that the target device is on a water surface and the learner device is submerged relative to the target device.

23. A method for tracking a target device, the method comprising:
receiving, at a target device, a request to perform a route-instruction operation;
sending a query for operation mode;
receiving a mode of operation;
when the mode of operation is “replay:”
sending a query for a replay-file name;
receiving a filename of a replay file;
obtaining location information from the replay file corresponding to filename; and
transmitting the location information to a learner device.
